(19) United States
(12) Patent Application Publication
(10) Pub. No.: US 2007/0214106 A1
(43) Pub. Date: Sep. 13, 2007

(54) Iconographic-based attribute mapping system and method

(76) Inventors: Julia K. Johnston, Toronto (CA); Ariel Dana McNichol, Los Angeles, CA (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/372,778

(22) Filed: Mar. 10, 2006

(51) Int. Cl. G06F 17/30

(52) U.S. Cl. 707/2

(57) ABSTRACT

A method for creating a representation having iconographic elements to represent the attributes of a subject. The method includes defining the at least one iconographic element of the representation, defining the at least one attribute of the subject, associating the at least one attribute with the at least one attribute set, associating the at least one attribute set with the at least one iconographic element, and displaying the at least one iconographic element. Then it is determined whether one of the displayed iconographic elements is selected. If so then each attribute of the associated attribute set is displayed. Optionally, attributes can be defined as being either viewable or non-viewable. If an associated attribute is determined to be a non-viewable attribute then the associated attribute is not displayed. If it is determined to be a viewable attribute then it is displayed.

### FIELD

The embodiments described herein relate to the creation and management of electronic representations and profiles and in particular to an iconographic-based attribute mapping system and method.

### BACKGROUND

Communications technology is becoming increasingly pervasive and integrated into the daily routines of individuals and organizations. Moreover, the communication technology itself is becoming increasingly integrated. In particular, on-line navigation of the Internet is now possible from various different devices, including desktop computers, laptops, personal data assistants (PDA), and cellular telephones.

Not surprisingly, the scope of the communication is also increasing at an extremely fast rate. Individuals use the Internet for a wide variety of reasons including business, banking, networking, and social communications. With the increase in these communications, users are interacting online, with each other and with organizations, more and more. However, many of these interactive forums are rather specialized and there are often a large number of forums and services occupying the same niche.

Consequently, it is not unusual for users to interact in many different online forums, often even for the very same service or purpose. This in turn translates into users having many on-line profiles and results in their personal information being disseminated within many different databases. This can be inconvenient in that it makes it difficult to keep track of what information is where and when it comes time to update one's information the task of doing so becomes tedious and inaccurate.

As a result of the above-mentioned issues, some users often feel powerless and frustrated with respect to their various electronic profiles. These issue can also make users fearful of using the Internet and taking full advantage of online resources. Thus, there is a need to provide users with the ability to 5 manage and control their electronic profiles in an easier and more comprehensive way and to thereby make them feel more in control and secure.

This need is equally applicable to the users themselves, for their companies or for anything else for which they would like to create an electronic profile.

### SUMMARY

The embodiments described herein provide in one aspect, a method for creating a representation having at least two iconographic elements to represent at least two attributes of a subject, said method comprising:
(a) defining first and second iconographic elements of the representation;
(b) defining first and second attribute sets;
(c) associating the first attribute set with the first iconographic element and associating the second attribute set with the second iconographic element;
(d) defining first and second attributes of the subject;
(e) associating the first attribute with the first attribute set and associating the second attribute with the second attribute set;
(f) displaying the first and second iconographic elements;
(g) determining whether one of the displayed iconographic elements is selected; and
(h) if (g) is true, then displaying the associated attribute of the associated attribute set.

The embodiments described herein provide in another aspect, a system for creating a representation having at least one iconographic element to represent at least one attribute of a subject, said system comprising:
(a) a memory for storing at least one iconographic element of the representation, at least one attribute and at least one attribute set of the subject;
(b) a processor coupled to the memory for:
   (i) associating the at least one attribute with the at least one attribute set;
   (ii) associating the at least one attribute with the at least one iconographic element;
   (iii) displaying the at least one iconographic element;
   (iv) determining whether the at least one displayed iconographic element is selected; and
   (v) if (iv) is true, then displaying the at least one attribute of the associated at least one attribute set.

The embodiments described herein provide in another aspect, a computer-readable medium having stored thereon a plurality of instructions, the plurality of instructions including instructions which, when executed by a processor, cause the processor to perform a method for creating a representation having at least one iconographic element to represent at least one attribute of a subject, said method comprising:
(a) defining first and second iconographic elements of the representation;
(b) defining first and second attribute sets;
(c) associating the first attribute set with the first iconographic element and associating the second attribute set with the second iconographic element;
(d) defining first and second attributes of the subject;
(e) associating the first attribute with the first attribute set and associating the second attribute with the second attribute set;
(f) displaying the first and second iconographic elements;
(g) determining whether one of the displayed iconographic elements is selected; and
(h) if (g) is true, then displaying the associated attribute of the associated attribute set.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the icon-based attribute mapping system;

FIG. 2 is a flowchart diagram that illustrates the operation of the iconographic-based attribute mapping system of FIG. 1;

FIG. 3 is a flowchart diagram that illustrates the steps taken by the configuration module to create a representation;

FIG. 4 is a flowchart diagram that illustrates the steps taken by the configuration module to gather subject attributes;

FIG. 5 is a flowchart diagram that illustrates the operation of the display module of the attribute mapping system of FIG. 1;

FIG. 6A is a flowchart diagram that illustrates the operation of the agent module of the attribute mapping system of FIG. 1;

FIG. 6B is a flowchart diagram that illustrates the operation of the utility module of the attribute mapping system of FIG. 1;

FIG. 6C is a schematic diagram illustrating a user interface view displaying suggested utilities, according to an exemplary embodiment of the attribute mapping system of FIG. 1

FIG. 7 is a flowchart diagram that illustrates the operation of the modification module of the attribute mapping system of FIG. 1;

FIG. 8 is a schematic diagram illustrating a user interface view displaying a social representation, according to an exemplary embodiment of the attribute mapping system of FIG. 1;

FIG. 9 is a schematic diagram illustrating a user interface view displaying an alternative social representation, according to an exemplary embodiment of the attribute mapping system of FIG. 1;

FIG. 10 is a schematic diagram illustrating a representation of FIG. 8, with the icon associated with the “mood and blog” attribute selected;

FIG. 11 is a schematic diagram illustrating a representation of FIG. 8, with the icon associated with the “music” attribute selected;

FIG. 12 is a schematic diagram illustrating a representation of FIG. 8, with the icon associated with the “what I like to see” attribute selected;

FIG. 13 is a schematic diagram illustrating a representation of FIG. 8, with the icon associated with the “real world basics” attribute selected;

FIG. 14 is a schematic diagram illustrating a representation of FIG. 8, with the icon associated with the “skills, career & education” attribute selected;

FIG. 15 is a schematic diagram illustrating a representation of FIG. 8, with the icon associated with the “lovelife” attribute selected;

FIG. 16 is a schematic diagram illustrating a representation of FIG. 8, with the icon associated with the “food, drink & parties” attribute selected;

FIG. 17 is a schematic diagram illustrating a representation of FIG. 8, with the icon associated with the “hobbies/gaming/fun” attribute selected;

FIG. 18 is a schematic diagram illustrating a representation of FIG. 8, with the icon associated with the “shopping” attribute selected;

FIG. 19 is a schematic diagram illustrating a representation of FIG. 8, with the icon associated with the “friends” attribute selected;

FIG. 20 is a schematic diagram illustrating a representation of FIG. 8, with the icon associated with the “personality type” attribute selected;

FIG. 21 is a schematic diagram illustrating a representation of FIG. 8, with the icon associated with the “style/flair & Humor” attribute selected;

FIG. 22 is a schematic diagram illustrating a representation of FIG. 8, with the icon associated with the “travel” attribute selected;

FIG. 23 is a schematic diagram illustrating a representation of FIG. 8, with the icon associated with the “my daily feeds” attribute selected;

FIG. 24 is a schematic diagram illustrating a representation of FIG. 8, with the icon associated with the “exercise & sports” attribute selected;

FIG. 25 is a schematic diagram illustrating a representation of FIG. 8, with the icon associated with the “rating and testimonials” attribute selected;

FIG. 26 is a schematic diagram illustrating a representation of FIG. 8, with the icon associated with the “bookmarks” attribute selected;

FIG. 27 is a schematic diagram illustrating a representation of FIG. 8, with the icon associated with the “pets & animals” attribute selected;

FIG. 28 is a schematic diagram illustrating a representation of FIG. 8, with the icon associated with the “leave mEgo strokes :)” attribute selected;

FIG. 29 is a schematic diagram illustrating a representation of FIG. 8, with the icon associated with the “events” attribute selected;

FIG. 30 is a schematic diagram illustrating a representation of FIG. 8, with the icon associated with the “photos/images” attribute selected;

FIG. 31 is a schematic diagram illustrating a user interface view for defining iconographic elements, according to an exemplary embodiment of the attribute mapping system of FIG. 1;

FIG. 32 is a schematic diagram illustrating a user interface view displaying a private representation, according to an exemplary embodiment of the attribute mapping system of FIG. 1;

FIG. 33 is a schematic diagram illustrating a representation of FIG. 32, with the icon associated with the “pets & animals” attribute selected;

FIG. 34 is a schematic diagram illustrating a representation of FIG. 33, with the “Upload Pictures” button selected;

FIG. 35 is a schematic diagram illustrating a representation of FIG. 27, with the “Related Content” button selected; and

FIG. 36 is a schematic diagram illustrating a user interface view for displaying password creation puzzles, according to an exemplary embodiment of the attribute mapping system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The invention may be implemented in hardware or software, or a combination of both. However, preferably, the invention is implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Each program may be access and executed by different means. In particular the program may be installed upon, accessed and executed on the same computing device. Alternatively, the computer program may be resident upon and executed on one computing device but accessed by another. The access could be accomplished through a web browser or similar means. The two devices could be connected through a network such as the Internet. Further still, the program may not be resident on any device but may be accessed and executed off a computer readable storage medium.

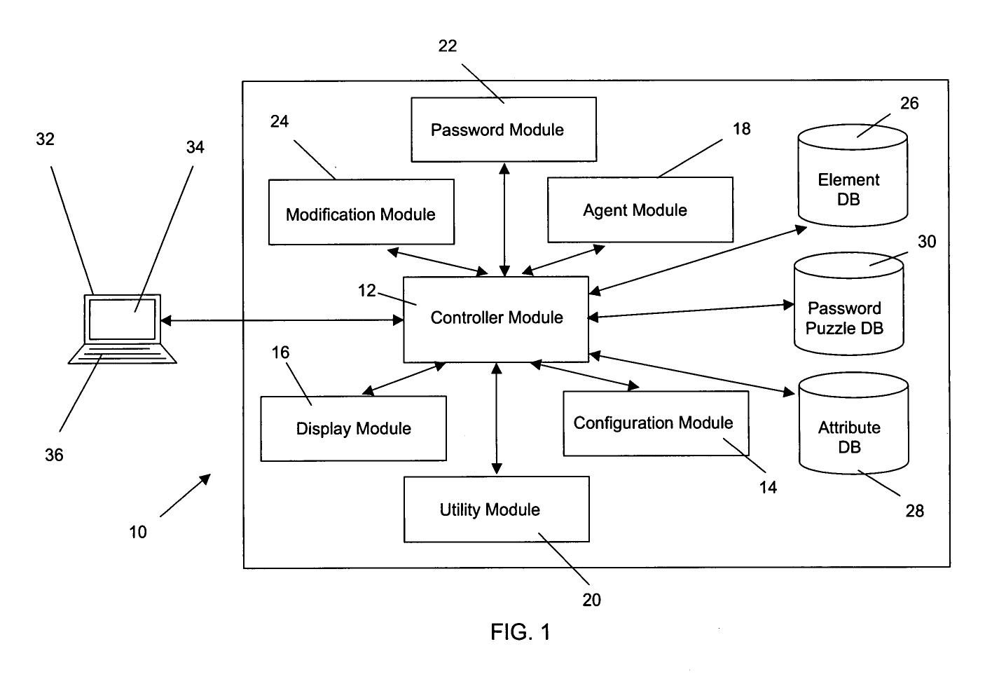

FIG. 1 is a block diagram illustrating an exemplary embodiment of an iconographic-based attribute mapping system 10. Attribute mapping system 10 comprises a number of functional elements including a controller module 12, a configuration module 14, a display module 16, a software agent module 18, a utility model 20, a password module 22, a modification module 24, an element database 26, an attribute database 28, and a password puzzle database 30. The controller module 12 controls and coordinates the actions of the other modules. A user terminal 32, with a display 34 and input device 36, is used to interface with attribute mapping system 10. User terminal 32 can be any number of devices including but not limited to a personal computer, laptop, cell phone, and personal data assistant (PDA).

Attribute mapping system 10 can be used to create a representation having iconographic elements. The representation can be used to represent any number of subjects, including but not limited to the user, a company, a pet, a car, or any other person, animal, object or possession, whether real or fictitious. The iconographic elements are in turn used to represent the attribute sets of the subject. The representation can take on any number of forms including an avatar representing a likeness of the subject or a chosen look of the subject. In any case, the attribute mapping system 10 can be used to create and manage electronic representations and corresponding profiles for the subject.

In addition, attribute mapping system 10, may be used to create multiple representations for the same subject. Furthermore, each representation could be of a different type. For example, a given subject could have utility, private, work, love and social representations. These representations can be displayed on various sites and forums. In one embodiment the utility representation is the most comprehensive representation. It contains all the attribute sets of the subject and allows the user to quickly see and change any of the subject's attributes. Thus, the utility representation may be displayed in a location that is accessible only to the user with an appropriate login.

Similarly, the private representation can be displayed at a site accessible only to those people with an appropriate login, which may have been provided to them by the user. In one embodiment the utility representation and private representation are the same and are only accessible to the user. The love representation can be posted to dating websites. Similarly, the social representation can be displayed on various social networking sites and forums. Alternatively, the representations can be displayed on their own dedicated websites. In any case, the representations can be made accessible by various means, including but not limited to via browser, side bar, as a widget or as a self-contained feed. The above examples are not meant to be limiting in any way.

The user can control access to the representations by various means. In particular, the user may make any of the representations private by requiring that a password be used to view the representation. In addition, the user is able to determine to which sites and forums he or she will make his or her representation available. By doing this the user can restrict the audience of each of her or his representations. This would make it unlikely for a potential employer interested in the user's work representation from stumbling upon the user's love representation. Similarly, it would make it unlikely that a potential date would see the user's work representation.

Furthermore, the user, by using a different name on each of her or his representations can make it so that viewers will not be able to link the user's love and work representations (or any other two representations) as belonging to the same person. Thus, all representations are subject to user-controlled levels of access and privacy. Moreover, attribute mapping system can inform the user regarding these issues and suggest that they make appropriate choices in terms of what information should be made available on which representations and to where different representation may be posted.

Attribute mapping system 10 associates attribute sets with iconographic elements. The attribute sets can relate to any number of aspects of the subject. In one embodiment each attribute set and all the attributes within a particular attribute set relate to a particular theme. A person viewing the representation may select an iconographic element to view the associated attribute set and attributes.

For example, if the subject is a person, a list of possible attribute sets may include a Mood indicator or Blog, Communication preferences, Audio preferences, Visual preferences (such as favorite things to see, read or watch), Lovelife, Skills/Career/Education, Food/Drinks/Parties, Hobbies/Gaming/Fun, Finances, Shopping, Personality Type, Health and Well Being, Exercise, Style/Flair/humor, Travel, Sports, Your News and Local Feeds, Friends, Testimonials, Search utility, and Password Utility. In those embodiments in which the attributes within a given attribute set are related to a particular theme, then the above list comprises the categories from which the attributes may be chosen. The above examples are exemplary only and not intended to be limiting in any way.

The attributes themselves may be any number of things including but not limited to feeds, data, text, rich media, software programs, or links. The feeds could include webfeeds utilizing any standard including but not limited to Rich Site Summary, RDF Site Summary, Really Simple Syndication, which can be referred to as RSS feeds, channels or streams. The feeds can also include any type of Extensible Markup Language (XML) feeds, including any feeds that may be developed in the future, and Operational Processor Markup Language (OPML) feeds. The text could be in Hyper Text Markup Language (HTML) with hypertext reference (href) tags. The Rich media could be any graphics file, movie file, audio file or the like. The software programs could be anything from software agents, widgets, gadgets, or applets. In addition, attributes may be links to any of the above mentioned attribute types or to anything else to which the user may wish to provide a link. In the case of links or feeds it is not necessary that the attribute mapping system 10 contain the data. Rather the data can be carried from where ever the feed or link originates and it need not be stored by attribute mapping system 10.

Each attribute set could contain any number of attributes. Alternatively, each attribute set could itself be an attribute, that is, a set of one attribute. In addition, an attribute set may be empty and not contain any attributes. In one embodiment, when an attribute set is empty, attribute mapping system 10 does not display anything when the associated iconographic element is selected. Thus, to a person viewing the representation, it would be as if that iconographic element did not have an associated attribute set. In another, embodiment however, attribute mapping system 10 would display something and indicate that the associated attribute set has not been populated.

Each attribute set need not be displayed with each representation that exists for a particular subject. For example, it may be inappropriate to display ones lovelife attribute set on one's work representation. As another example, the financial information attribute set can contain as attributes the user's credit card numbers, account numbers and similar information that the user may wish to restrict to his or her utility representation. Table 1 below shows an exemplary assignment of attribute sets for four different types of representations

TABLE 1

| Utility/Private | Social | Love | Work |
|---|---|---|---|
| Representation | Representation | Representation | Representation |
| Mood/Blog | Real World | Real World | First Name, |
| | Basics | Basics | Last Name |
| Communication | Audio | Audio | Mailing |
| | | | Address |
| Audio | Visual | Visual | Resume “X” |
| | | | consisting of: |
| Visual (favorite | Lovelife | Lovelife | Career |
| see/read/watch) | | | Overview |
| Lovelife | Skills/Career/ | Skills/Career/ | Objectives |
| | Education | Education | |
| Skills/Career/ | Food/Drinks/ | Food/Drinks/ | Education |
| Education | Parties | Parties | |
| Food/Drinks/ | Hobbies/Gaming/ | Hobbies/Gaming/ | History |
| Parties | Fun | Fun | |
| Hobbies/Gaming/ | Shopping | Shopping | Skills |
| Fun | | | |
| Finances | Personality/Type | Personality Type | Awards |
| Shopping | Style/Flair/humor | Style/Flair/humor | Affiliations/ |
| | | | Groups |
| Personality | Travel | Travel | Testimonials |
| Type | | | *linkedin feed. |
| Health & Well | Sports | Sports | |
| Being | | | |
| Exercise | Friends | | |
| Style/Flair/ | Testimonials | | |
| humor | (mEgo strokes) | | |
| Travel | Events | | |
| Sports | Bookmarks | | |
| Your News and | Images | | |
| Local Feeds | | | |
| Friends | | | |
| Testimonials | | | |
| Search utility | | | |
| Password | | | |
| utility | | | |
| EVENTS | | | |
| BOOKMARKS | | | |
| IMAGES | | | |

In addition, attribute mapping system 10 accepts information from users. It may also use data scraping and harvesting techniques to aggregate user information. In one embodiment it then uses this information to interface with other online forums that the user may access. It thereby keeps the information on these sites up to date.

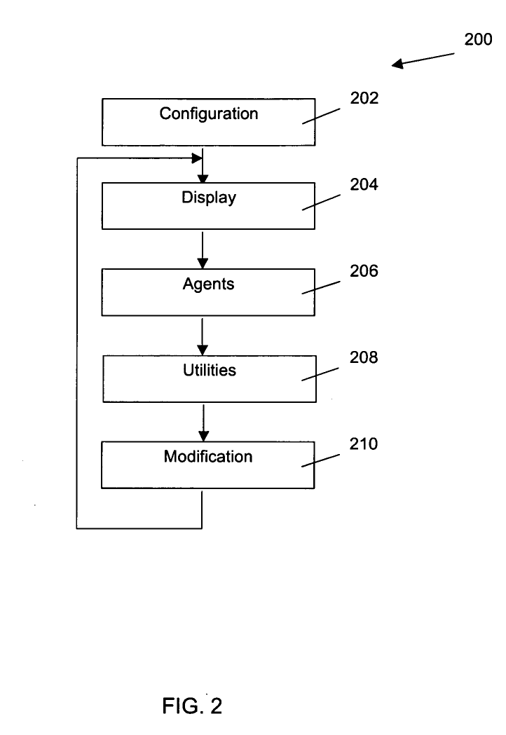

FIG. 2 is a flowchart that illustrates the basic steps 200 taken by attribute mapping system 10. At step (202), the configuration module 14 configures attribute mapping system 10. This includes creating a representation and collecting attributes as inputs. At step (204), the iconographic representation is displayed on display 34 of user terminal 32.

At step (206), agent module 18 causes agents, bots, widgets or algorithms to perform tasks based on the attributes of the subject. Such a task could, for example, consist of searching for items of interest on a network based on the attributes of the subject. At step (208), utility module 20 provides the user with suggestions regarding software agents, widgets, feeds, links, and gadgets that the user may be interested in. At step (210), the modification module 24 allows the user to modify the attributes of the subject or the appearance of the representation.

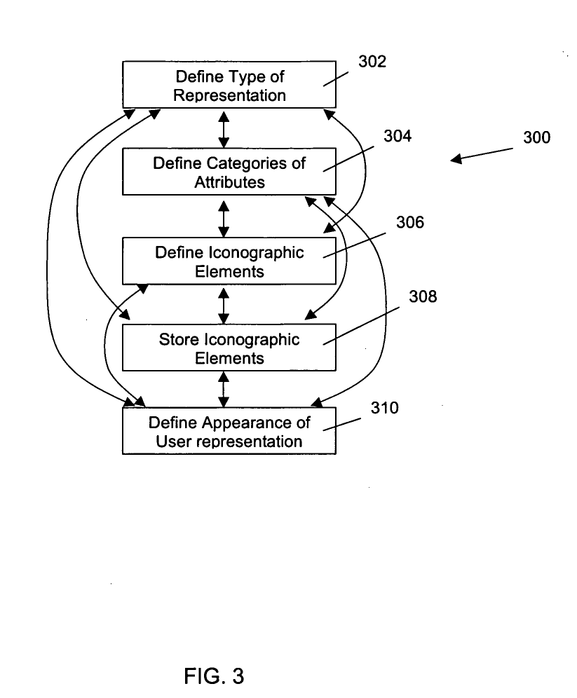

FIG. 3 is a flowchart that illustrates the steps 300 taken by configuration module 14 to create a representation having iconographic elements. It is important to note that steps need not occur in any particular order. In addition, the user may go back and forth form one step to another, or skip a step and come back or jump from step to step as he or she sees fit. At step (302), the type of representation is determined. In particular, the subject of the representation is determined. The subject could for example be the user him or herself, a company or a pet, etc. In addition, it is determined what form the representation will take. For example, the representation could be an avatar representing a desired image for the subject. On the other hand, if the subject is a company it could be the likeness of a company mascot or trademark. Alternatively, the representation could be as simple as a pull down menu or table. Thus, the representation need not take any particular form.

At this step, it is also determined what categories this particular representation falls into including but not limited to utility, private, work-related, social, and love. This can impact on where the representation is displayed and who may view it. The user can have any number of representations for the same subject. Alternatively, attribute mapping system 10 could be set up so as to only have one type of representation.

At step (304), the attribute sets are defined. As explained above, attribute sets can contain any number of attributes. Thus, for example, the financial information attribute set can contain as attributes the user's credit card numbers, account numbers and similar information.

As part of the defining step for attribute sets, it is determined with which representations or with which type of representation each attribute set will be displayed. For example, one may wish to specify that one's lovelife attribute set not be displayed with one's work representation. The user may assign various attribute sets to various types of representations. Alternatively, attribute mapping system 10 can automatically determine which attribute sets will be displayed with which types of representation. A user override could be provided, which would allow the user to change any of the default settings. For example, attribute sets such as financial information may be restricted to only being displayed with the utility representation. Table 1 above, illustrates an exemplary set of attribute assignments to different types of representations.

Other representations may have already been created by the user for this subject. If that is the case this step may comprise simply assigning existing attribute sets to the new representation. Thus the user may assign all, some or none of the existing attribute sets. Alternatively he or she may create new attribute sets.

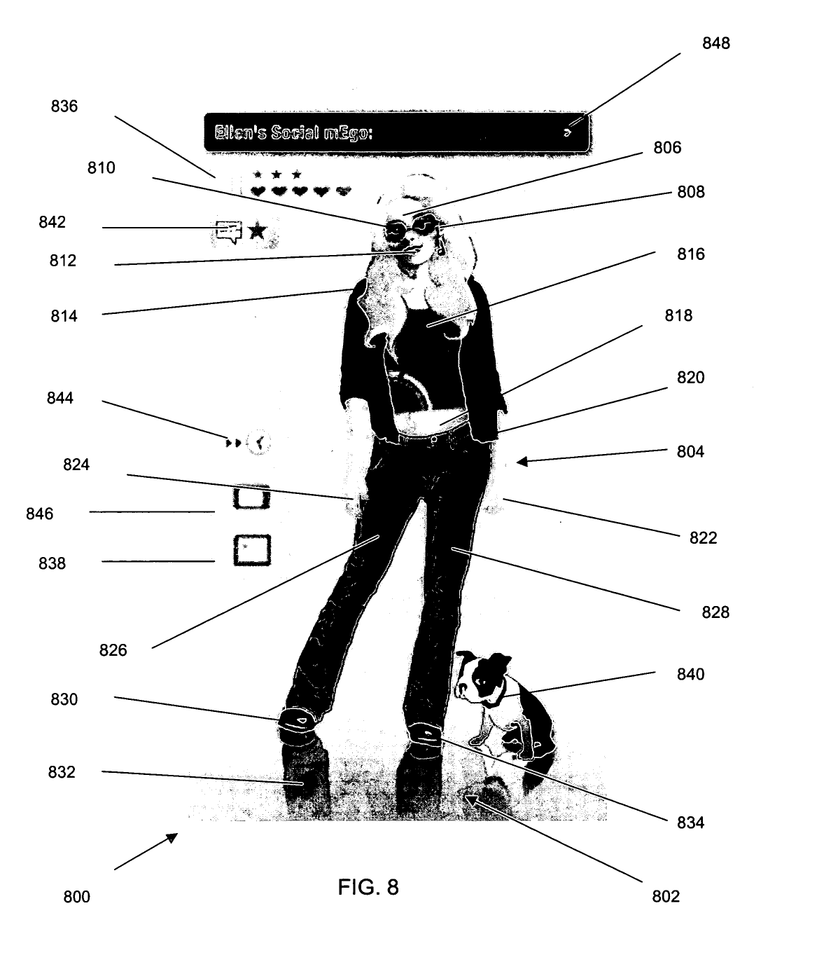

At step (306), the iconographic elements are defined and it is determined which attribute sets they will be associated with. For example, if the representation is an avatar, then the iconographic elements could be chosen to be the body parts of the avatar, including but not limited to the face, hair, eye, ear, nose, mouth, neck, heart, forehead, cheek, shoulders, left arm, right arm, left elbow, right elbow, right hand, left hand, left foot, right foot, stomach, chest, groin, hips, left knee, right knee, left thigh, right thigh, left calf, right calf, left shin, right shin, left big toe, right big toe, ears, left heel, and right heel (e.g. the avatar in FIG. 8).

An attribute set that has been assigned to a particular iconographic element of a particular representation may be referred to as an “associated attribute set” of the iconographic element for that representation. However, if at step (304) it is determined that a given attribute set will not be displayed in a given representation, then for the purposes of that representation, that attribute set will not be an associated attribute set of any iconographic element. Thus, continuing the example above, if financial information is restricted to being displayed on only the utility representation then for all other representations, the financial information attribute set is not an associated attribute for any iconographic element.

The choice of element used to represent an attribute set could be suggestive of the attribute set. Alternatively, the choice of element could be arbitrary. At step (308), the iconographic elements are stored in the element database 26. Thus, if the representation is an avatar and it is desired that the elements be suggestive of the attribute sets then the heart can be chosen to relate to the subject's lovelife and the ear to the subject's audio preferences. This is only meant as an example and is not intended to be limiting in any way.

At step (310), the user defines the appearance of the representation. For example, if at step (302), it was determined that the representation will be an avatar representing a likeness of the user or a chosen look of the user, then at this step the specific appearance of the avatar is defined by making it appear similar to the user or to the user's chosen look in some manner.

The above steps can be repeated to create as many representations of a particular subject as desired. As explained above, the steps may be done in any order. Furthermore, attribute mapping system can be configured such that the user may go back and forth between steps or jump from step to step in any order. It should also be understood that if there is more than one representation for a given subject each can be made to have a different appearance.

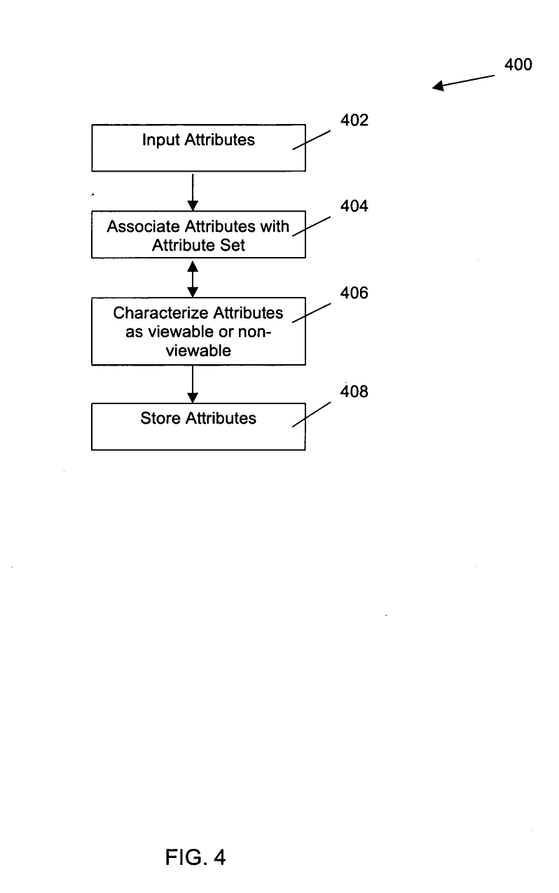

Reference is now made to FIG. 4 which is a flowchart that illustrates the steps 400 taken by the configuration module to obtain information relating to a subject's attributes for use within the attribute mapping system 10. At step (402) the user inputs the subject's attributes. This can be done in a variety of ways. For example, the user may be prompted to enter attributes based on the attribute sets defined in step (304) of FIG. 3. Alternatively, instead of prompting the user in the standard manner a game like experience can be used to illicit the information from the user. Another alternative could be to use data scrapping and harvesting techniques to obtain information about the user in places where it may be stored, such as the user's hard drive or online sites containing the user's information. Preferably the data scrapping and harvesting is user controlled thereby allowing the user to see and determine what information is gathered and from where.

At step (404) the configuration module associates each inputted attribute with an attribute set. The user may specify which attribute set(s) each attribute may belong to. Alternatively the association may be made by attribute mapping system 10. In particular, if the user is prompted to enter inputs based on attribute sets defined in step (304) of FIG. 3 then the association will be rather easily made. At step (406), the attributes are designated as viewable or non-viewable with respect to each of the representations. The default is for each attribute to be viewable. However, the user may wish to specify that certain attributes only be viewable on certain representations. This provides an additional level of privacy over and above that provided by the display restrictions the user can apply to each attribute set as a whole. Thus, the user is afforded the ability to specify that a particular attribute not be displayed on a given representation even though the attribute set with which that attribute is associated is displayed on that representation. At step (408), the attributes are stored in attribute database 28.

It should be understood that the steps described above with respect to the creation and configuration of representations need not be separate and distinct from the steps described with respect to the inputting of attributes. In particular, one may influence the other. For example, the inputting of certain attributes may cause the representation to be altered or configured in a particular manner. As an example consider a representation that is an avatar, which represents a likeness of the user. In one embodiment the attributes entered by the user such as his or her age, gender, height, weight, body type, and ethnicity may cause the appearance of the avatar to change in a manner that reflects the value of the attribute. Thus, entering a height that is above average may cause the avatar to be taller than usual. The effect could be similar for other attributes as well.

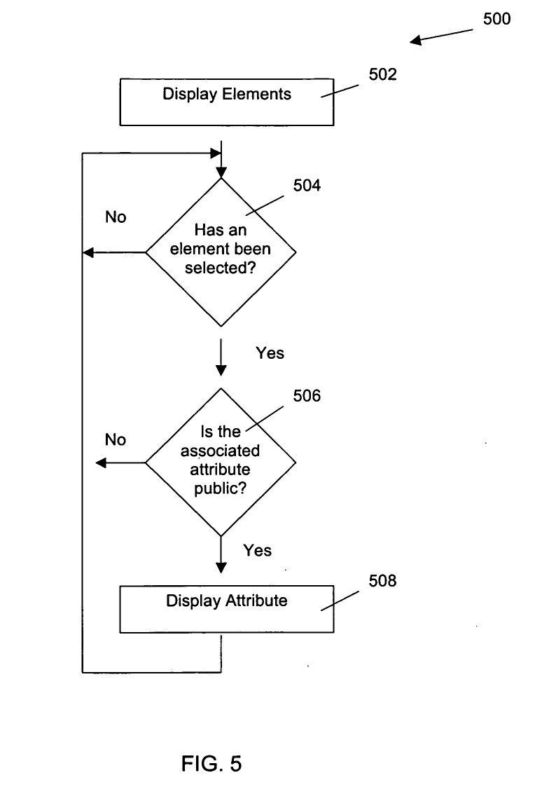

Reference is now made to FIG. 5, which in a flowchart illustrates the steps 500 taken by the display module 16 of the attribute mapping system 10, in displaying the iconographic elements and attributes. At step (502), the iconographic elements are displayed. At step (504), it is determined whether a person viewing the representation has selected an iconographic element of the representation. The selection of an element may, for example, be performed by rolling over the element with a cursor or by double clicking on it with a mouse. If an element has been selected, then the process continues on to step (506). If not, then step (504) is repeated.

At step (506), it is determined whether or not for this particular representation there is an attribute set associated with the selected element. If there is no associated attribute set, then step (504) is repeated. If there is an associated attribute set, then step (508) is executed. At step (508) all the attributes in the attribute set identified at step (506), except those specified by the user not to be displayed with this particular representation or type of representation in step (406) of FIG. 4 above, are displayed.

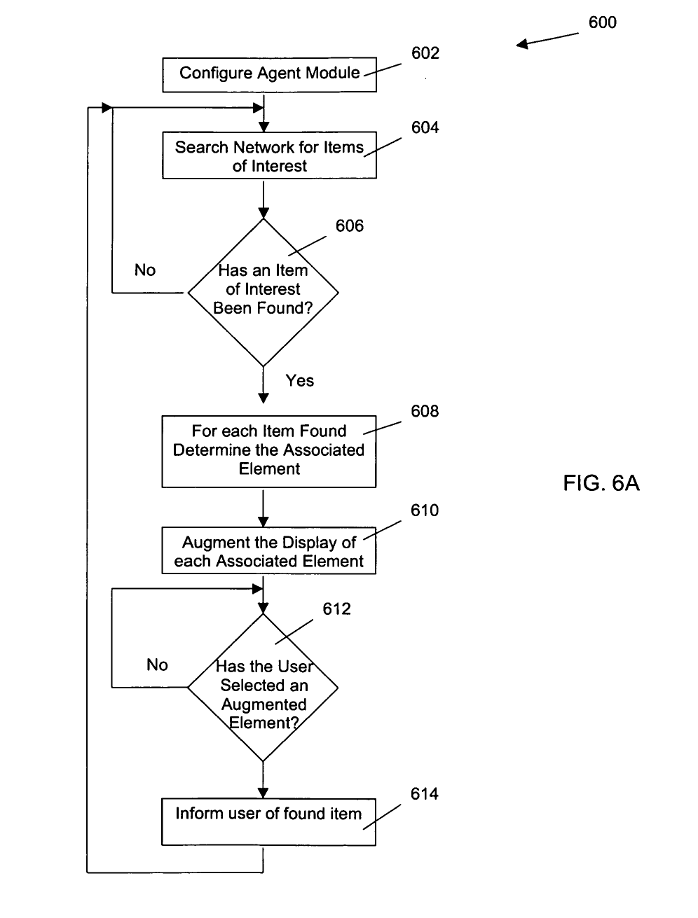

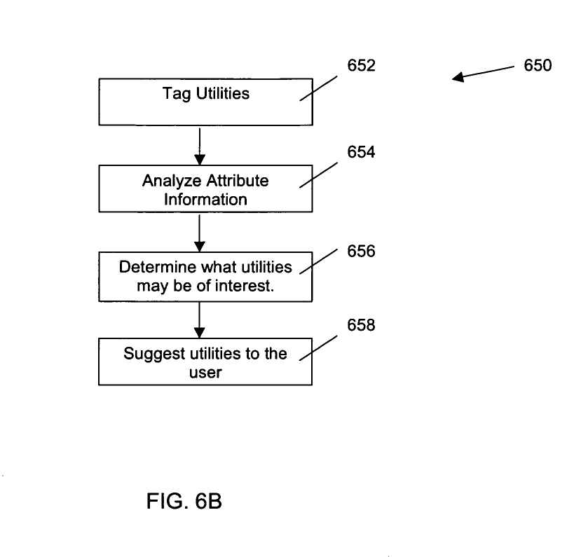

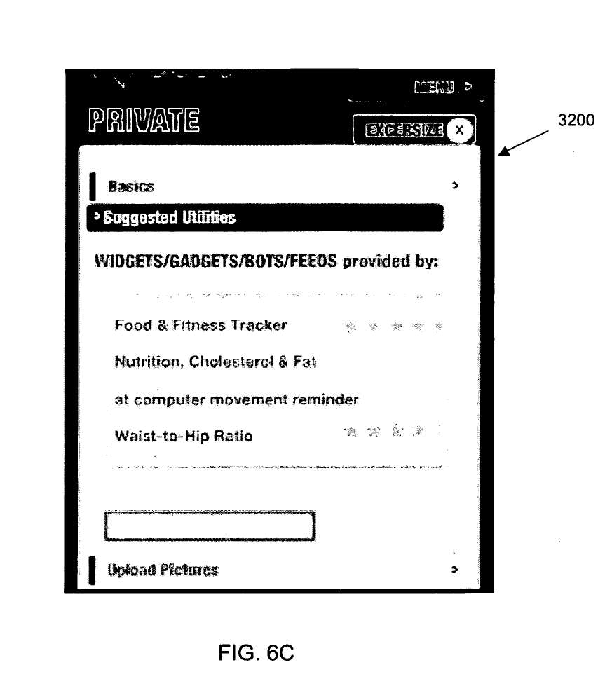

Reference is now made to FIG. 6A, which is a flowchart that illustrates the steps 600 taken by the agent module 18 of the attribute mapping system 10. As is conventionally known, software agents are software programs that allow users to, among other things, program requests for information. Various types of software agents may be utilized, including but not limited to: intelligent, autonomous, anthropomorphic, multi-agent systems, distributed, mobile, bots, widgets, and gadgets.

In a first embodiment, at step (602), the agent module 18 is configured. At this point, the user inputs the kinds of software agents or content he or she is interested in using or seeing. This could be done, for example, by designating certain categories of attributes of interest. As an example, a user can indicate that she or he is interested in a shopping agent for clothing, books or music or any other item of interest.

At step (604), agent module 18 causes software agents to search a network for the items of interest based on the configuration step (602) above and the inputted attributes. The actual software agent or bot could be part of attribute mapping system 10. Alternatively, attribute mapping system 10, may utilize external software agents or bots to perform these tasks. The network that is searched could be any network to which attribute mapping system 10 has access. An example of such a network could be the Internet.

At step (606), it is determined whether an item of interest has been found. If not, then step (604) is repeated. If an item of interest has been found, then step (608) is executed. At step (608) agent module 18, associates each item found with an iconographic element. At step (610), agent module 18 causes display module 16 to augment the display of an associated element in order to notify the user that an item has been found. Augmentation of the display of an associated element can be accomplished by various means, including, for example changing the color of the iconographic element, causing it to blink or flash. Alternatively, attribute mapping system 10 can provide some audible indication (e.g. “more music has been found for you”). In addition, the user may also be notified through other means including but not limited to an email (including audio or video email), a phone call, a short message service (SMS) message, and a biomechanical or a chemical indicator. Further still, the attribute set could be augmented by adding a submenu item, which provides information with respect to the item of interest. In addition, if appropriate, a link to the found item could be provided as an attribute under the relevant attribute set.

At step (612), it is determined whether the user has selected one of the augmented elements. If not, then step (612) is repeated. If yes, then at step (614) the user is provided with information regarding the item associated with the selected augmented element.

Reference is now made to FIG. 6B, which is a flowchart illustrating the steps 650 taken by the utility module 20. Utility module 20 provides the user with contextual suggestions regarding various utilities. Utility module 20 may choose and suggest appropriate utilities through the use of appropriate algorithms and heuristics. The utilities can be anything that the user may be interest in using or including as attributes such as software agents, websites, data, feeds, widgets, media, content, and tools. Any of these items could be provided by third parties or they may be provided by attribute mapping system 10. At step (652) utility module 20 locates and tags utilities that may be relevant to various attribute sets. Table 2 below illustrates a set of tagged utilities and the corresponding attribute sets.

TABLE 2

| | Attribute Sets | | | | | | |
|---|---|---|---|---|---|---|---|
| Widget/Gadet/ | | | | Fitness & | | | |
| link/feed/agent | Audio | Travel | Shopping | Nutrition | Communication | Pets | Lovelife |
| Currency | | X | X | | | | |
| Calculator | | | | | | | |
| Worldtime clock | | X | | | | | |
| Diet Calculator | | | | X | | | X |
| Travel Bot | | X | | | | | |
| New match.com | | | | | | | X |
| matches | | | | | | | |
| Dogster.com tip | | | | | | X | |
| of the day | | | | | | | |
| Quote of the | | | | | X | | |
| Day | | | | | | | |
| Language | | X | | | X | | |
| Translator | | | | | | | |
| iTunes Widget | X | | | | | | |

At step (654) utility module 20 analyses the information gathered regarding the subject, including the attributes inputted by the user and the attributes gathered through the above-described data scraping techniques. At step (656) utility module 20, determines which utilities may of interest to the user based on all or some of the information gathered with respect to the subject. For example, if the user entered an attribute indicating that they planned to travel in the near future, then utility module 20 may determine that a currency exchange calculator may be of interest to the user.

At step (658) utility module 20 suggests to the user any of the utilities that it has determined may be of interest to the user. This could be done by any of the methods explained above with respect to the steps (610) and (612) of FIG. 6A. For example the display of the related iconographic element could be altered or a message could be sent to the user. Regardless of the means used, utility module 20 can provide the user with information on how and where to obtain the relevant software agent. For example, utility module 20 could provide a link to a website or software agent.

Reference is now made to FIG. 6C, which illustrates a user interface view 3200 showing various suggested utilities. In particular these utilities are suggested for the lovelife attribute set. User interface 3200 will be described in greater detail below. This type of interface could be utilized by either agent module 18 or utility module 20 for suggesting utilities or found items to the user.

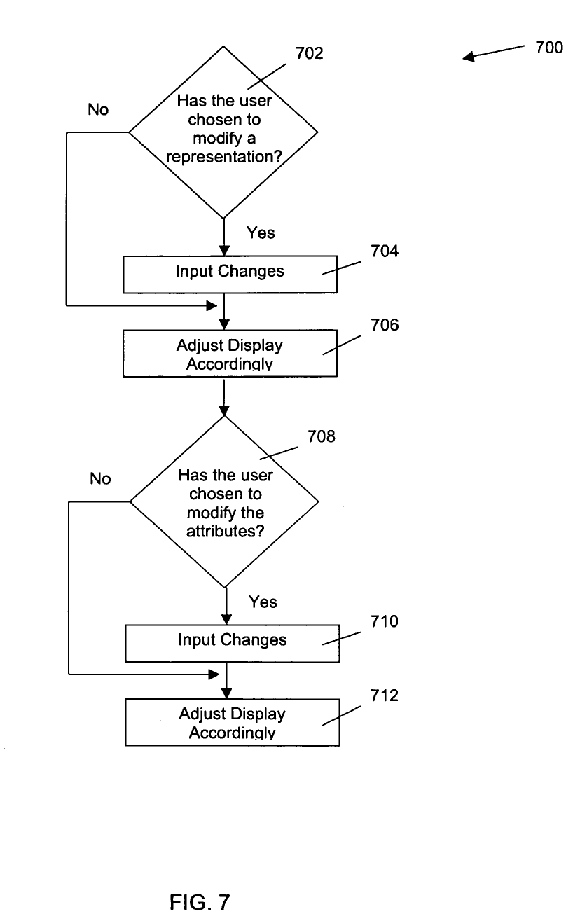

Reference is now made to FIG. 7, which is a flow chart illustrating the steps 700 taken by the modification module 24. The modification module 24 allows the user to alter representations once they have been created. Alternatively, he or she may use the modification module 24 to alter the attributes for a given subject. In addition, the user may reenter any of the steps taken by the configuration modules 14 at any point to, for example, create new representations for existing subjects and optionally to specify that these new representations, are utility, private, work, love or social representations. Alternatively, the user may create completely new representations for new subjects. Furthermore, in some embodiments the configuration and modification modules are not separate and distinct from each other.

At step (702), it is determined whether the user has chosen to modify a representation. If not, then the modification module 24 proceeds to step (706). If yes, then at step (704), the user inputs the modifications. At step (706), the display of the representation is modified according to the changes, if any, made at step (704).

At step (708), it is determined whether the user has chosen to modify any of the attributes. If not, then the modification module 24 proceeds to step (712). If so, then at step (710), the user inputs the modifications. This step could involve things such as, changing the information associated with a given attribute, attaching pictures, and changing the status of the attributes from viewable to non-viewable or vice versa, or change the association of attribute sets to different iconographic elements, or restricting attribute sets from being displayed with certain representations with which they were previously displayed, or any other changes the user may wish to make. At step (712), the display is altered according to the changes, if any, made at step (710). This could for example, involve no longer displaying attributes or attribute sets, in certain representations.

As stated above the modification and configuration modules need not be distinct from each other. Furthermore, there may be multiple configuration and modification modules. For example, one embodiment may have a detailed guided module that carefully guides the user through the process of creating, configuring or modifying the representation and attributes. The same embodiment may have a simpler module for people that are more familiar with the process and do not require as much guidance. Yet another even simpler module can allow the user to make minor changes to the attributes and the appearance of the representation. Thus, the modification and configuration modules can be implemented in a variety of manners.

FIG. 8 is an illustration of a user interface view 800 of a representation 802 used in an exemplary embodiment of attribute mapping system 10. In this example embodiment, the subject is a user named “Ellen”. This particular representation is a social representation and is therefore public. Thus, any attributes designated as private will not be displayed. The user can have any number of other representations that are either public or private. In addition, the appearance of each representation may be different from or similar to this particular representation.

The main portion of representation comprises an avatar 804. Avatar 804 can be chosen to have any appearance desired by the user. For example, avatar 804 could be chosen to represent a likeness of the subject or a chosen look of the subject, which may be the user. The avatar 804 has body parts that are iconographic elements. However, as shown, there are other iconographic elements, which are not body parts, as well. Certain body parts of the avatar as well as the other iconographic elements are associated with certain attributes of the subject.

In this example, the representation has a number of iconographic elements which may be chosen, including: the face 806, ear 808, eyes 810, mouth 812, shoulders 814, heart 816, stomach 818, hips 820, left hand 822, right hand 824, right thigh 826, left thigh 828, right foot 830, reflection 832, left foot 834, testimonials button 836, bookmarks button 838, pet 840, leave feedback button 842, events button 844, photos/images button 846. A person viewing the representation can access the subject's attribute sets associated with each iconographic element by selecting that element.

The above-mentioned iconographic elements can be associated with any attributes sets of the subject. Table 3 illustrates an exemplary set of relationships between iconographic elements and the subject attribute sets for the example embodiment of the attribute mapping system 10. As can be seen from the table, not all attribute sets need to be mapped to the body parts of the avatar. Other iconographic elements may be used apart from the avatar.

TABLE 3

| ELEMENT | ATTRIBUTES |
|---|---|
| Face | Mood Today and Blog |
| Ear | Music |
| Eyes | What I like to see |
| Mouth | Real world basics |
| Shoulders | Skills, career and education |
| Heart | Lovelife |
| Stomach | Food, drink & parties |
| Hips | Hobbies/Gaming/Fun |
| Left Hand | Shopping |
| Right Hand | Friends |
| Right Thigh | Personality Type |
| Left Thigh | Style/Flare & Humor |
| Right Foot | Travel |
| Reflection | My Daily Feeds |
| Right Foot | Exercise & Sports |
| Testimonials button | Testimonials |
| Bookmarks button | Bookmarks |
| Pet button | Pets & Animals |
| Leave Feedback button | Feedback |
| Events button | Events |
| Photos/Images button | Photos/Images |

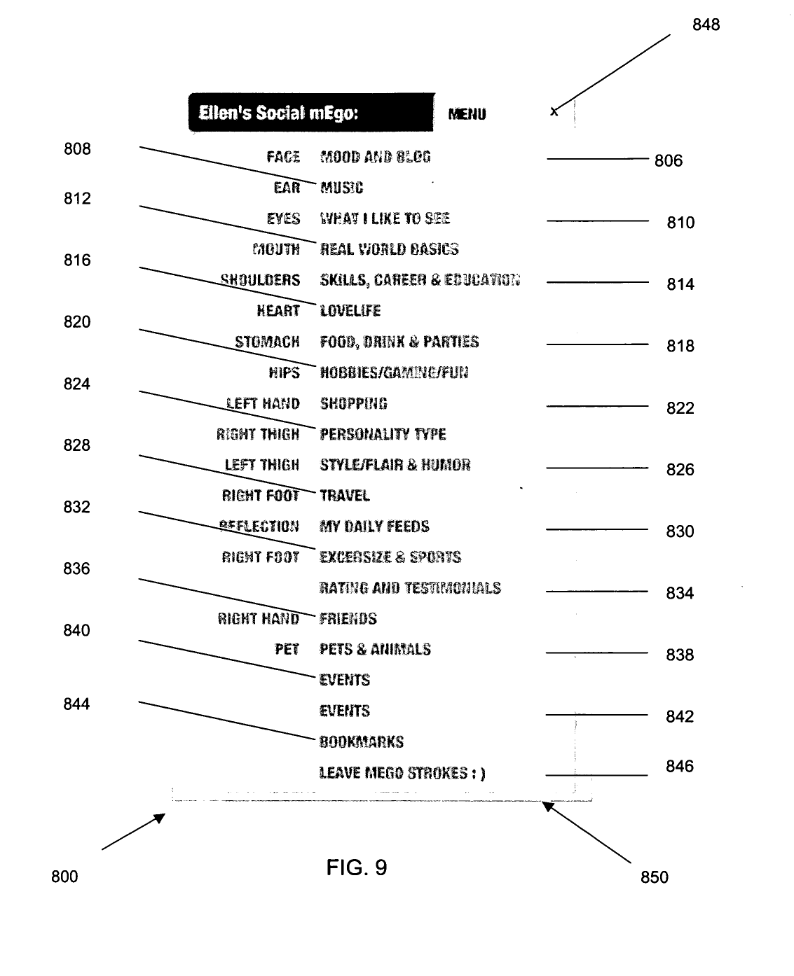

Reference is now made to FIG. 9 which is a schematic diagram that shows the contents of the pull down menu button 848 located within the user interface view 800 (FIG. 8). Selection of the menu button causes a representation 850 to appear in the form of a table similar to that of Table 3 in 10 place of representation 802. The entries in the table are now the iconographic elements. A person viewing representation 850 can access the subject's attributes by selecting the table entries in the same way that they could by selecting the iconographic elements of representation 802.

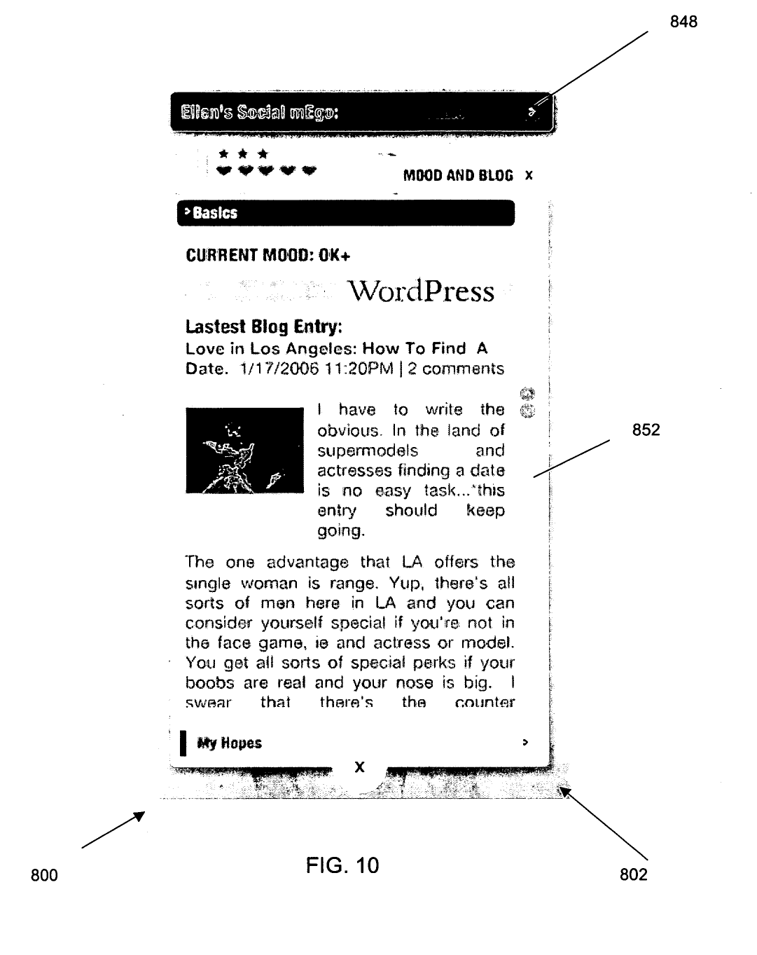

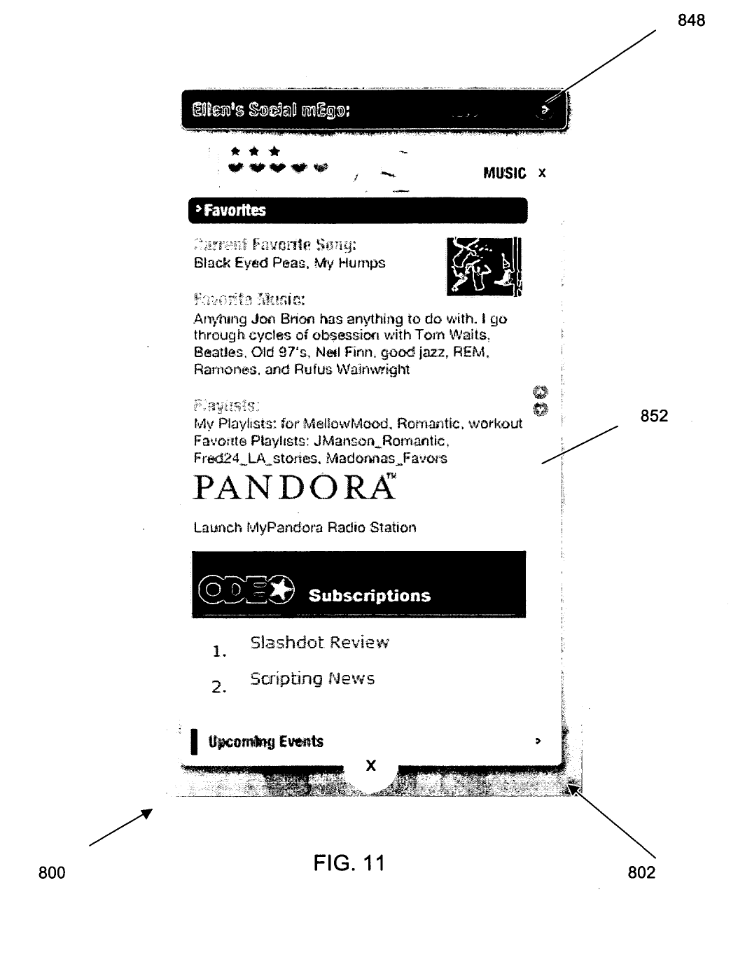

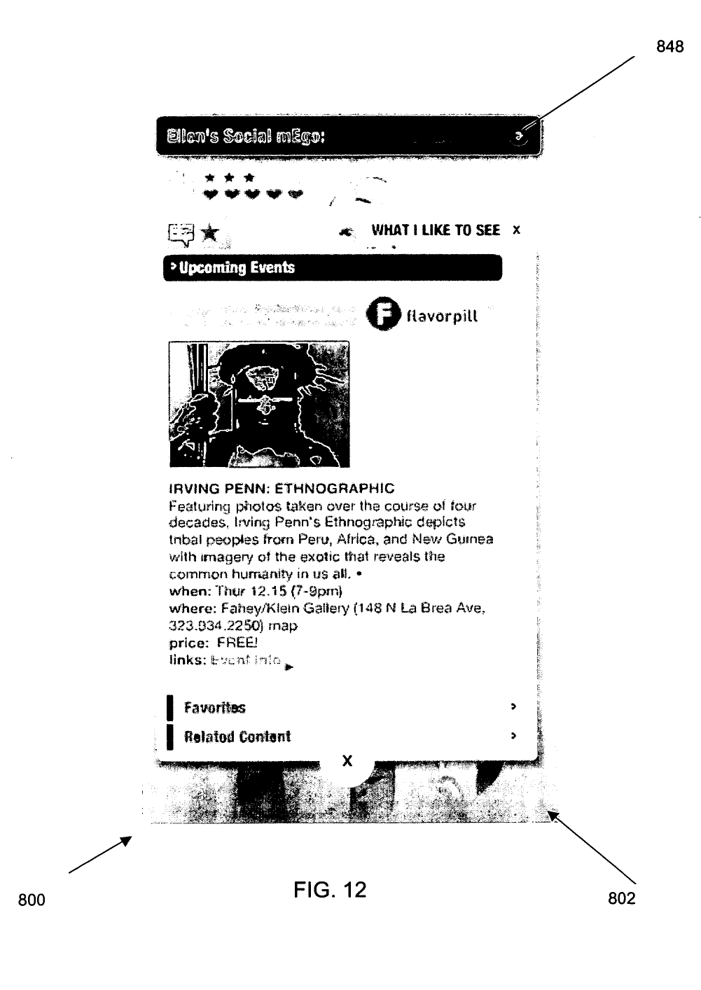

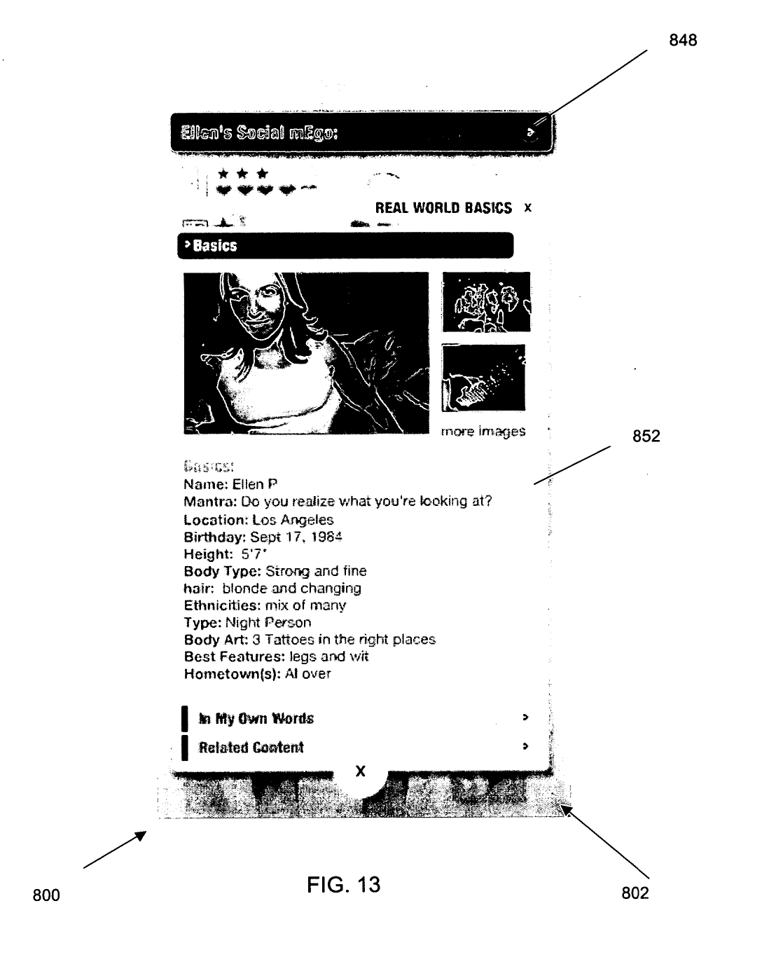

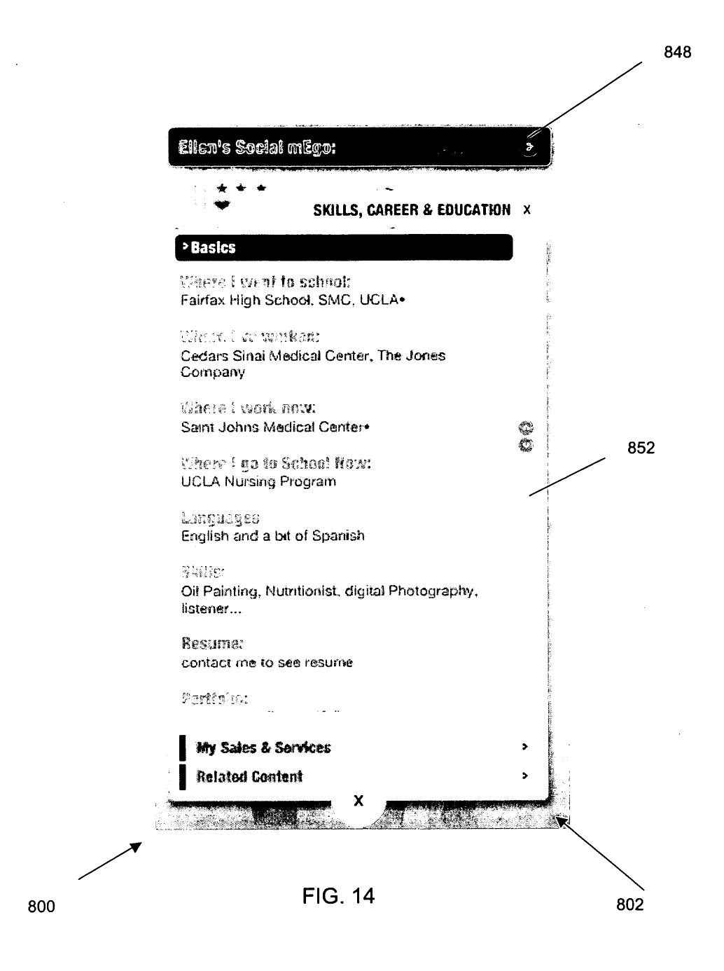

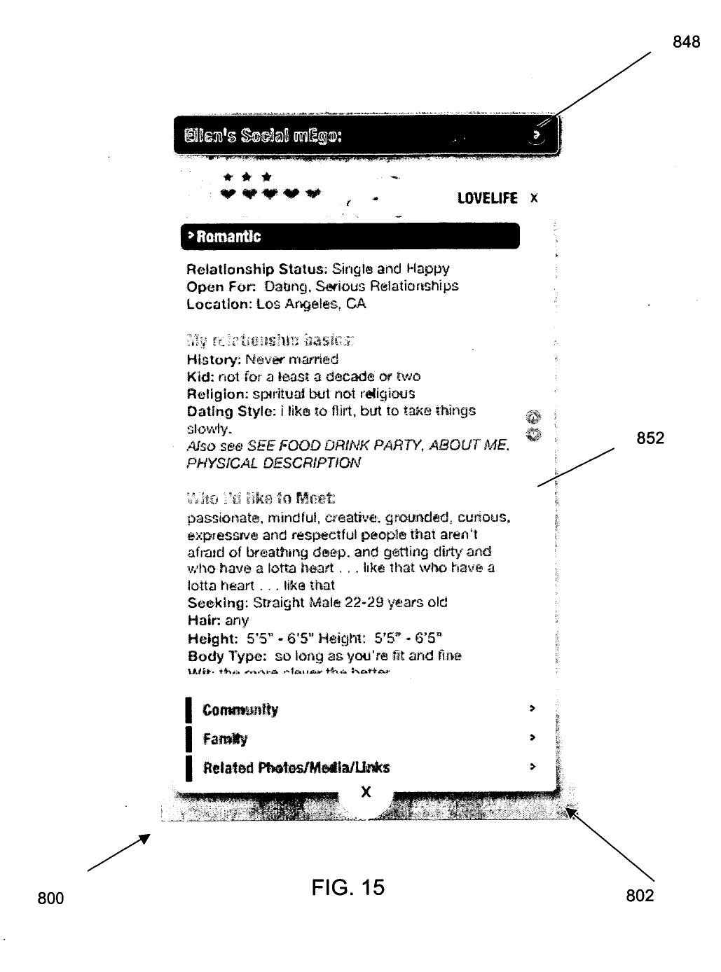

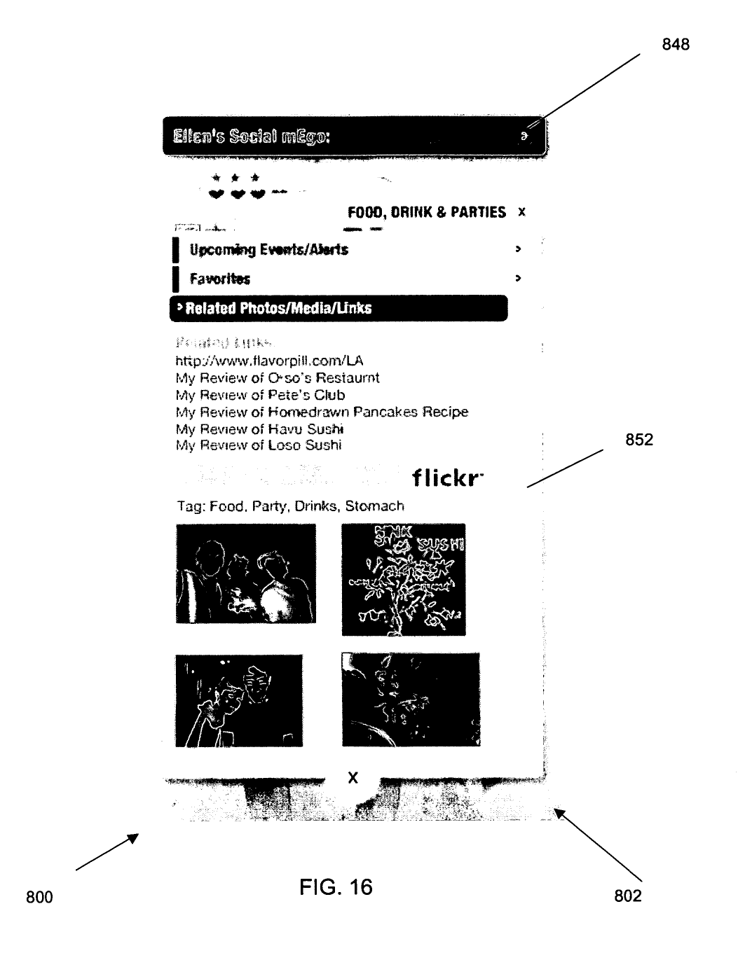

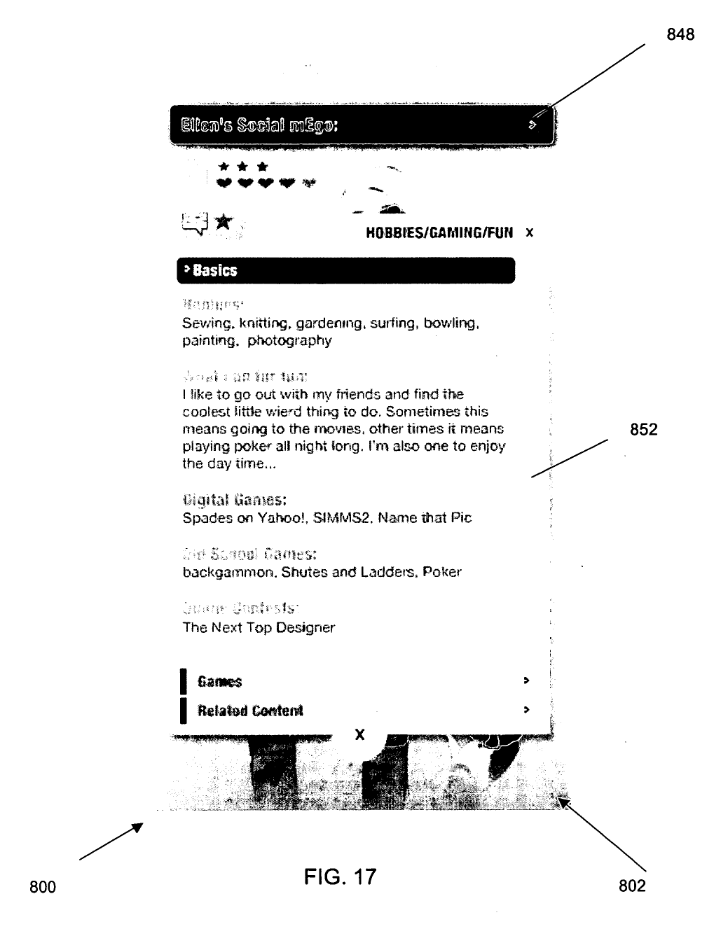

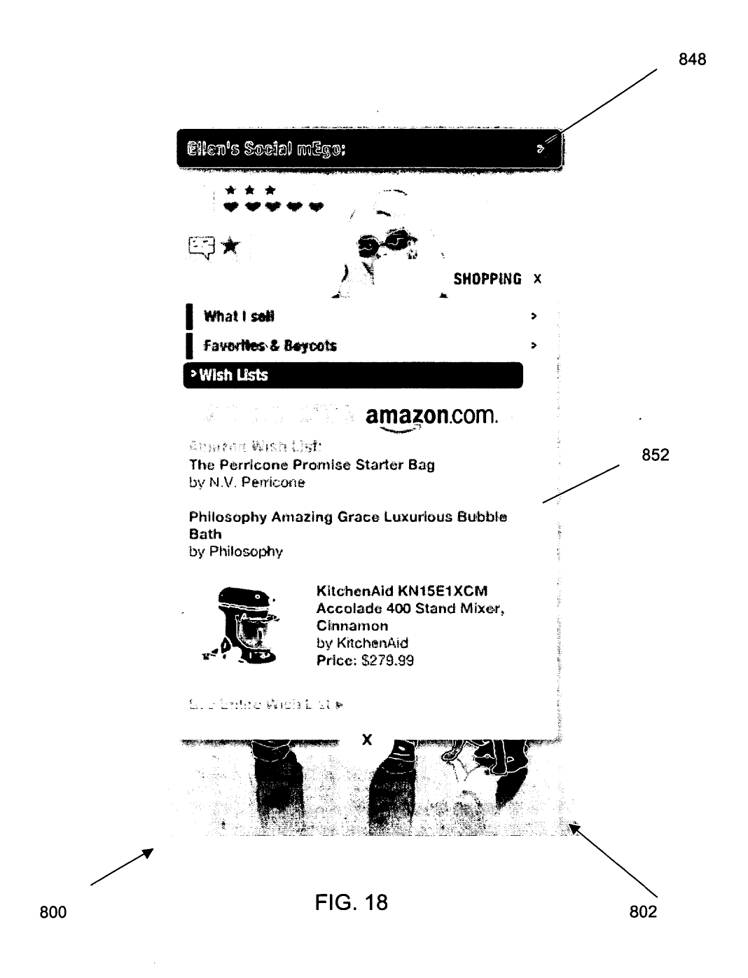

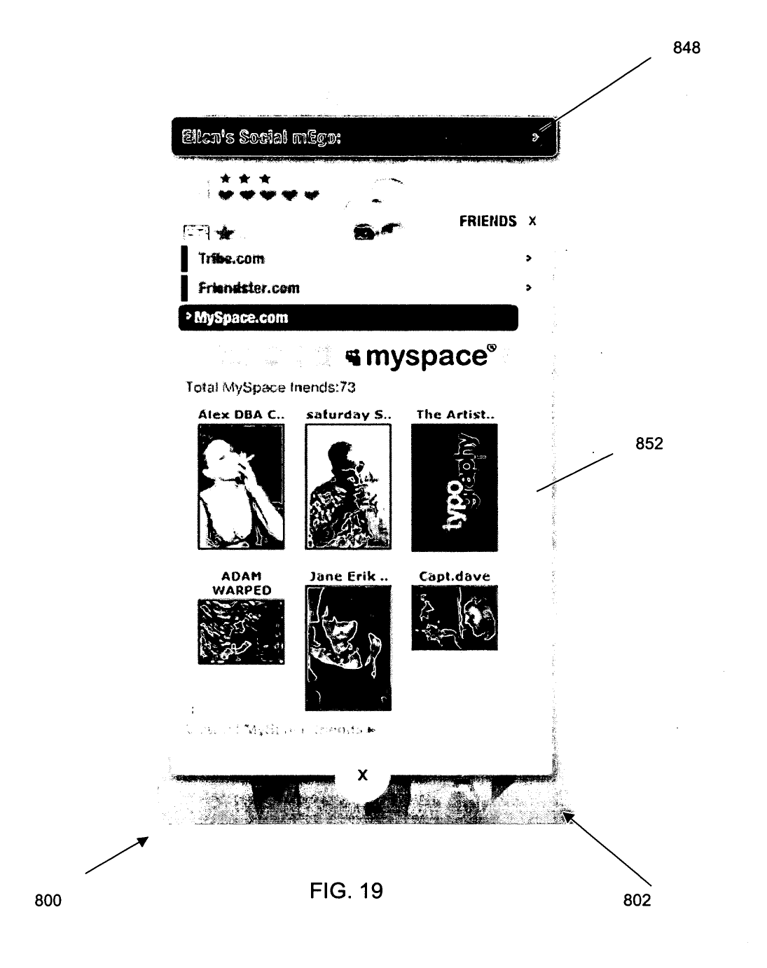

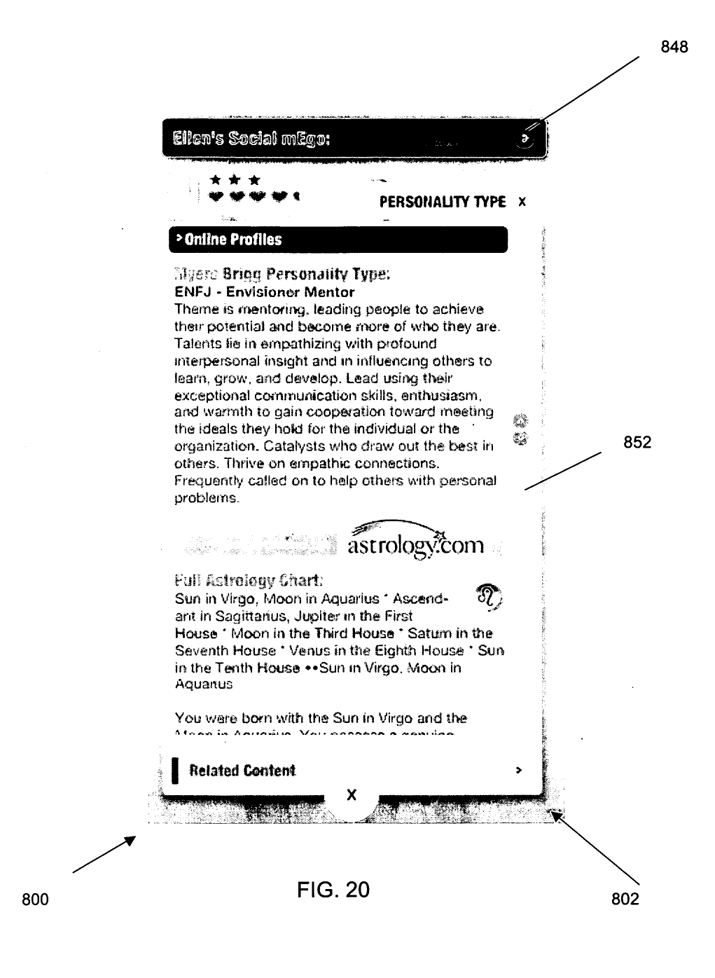

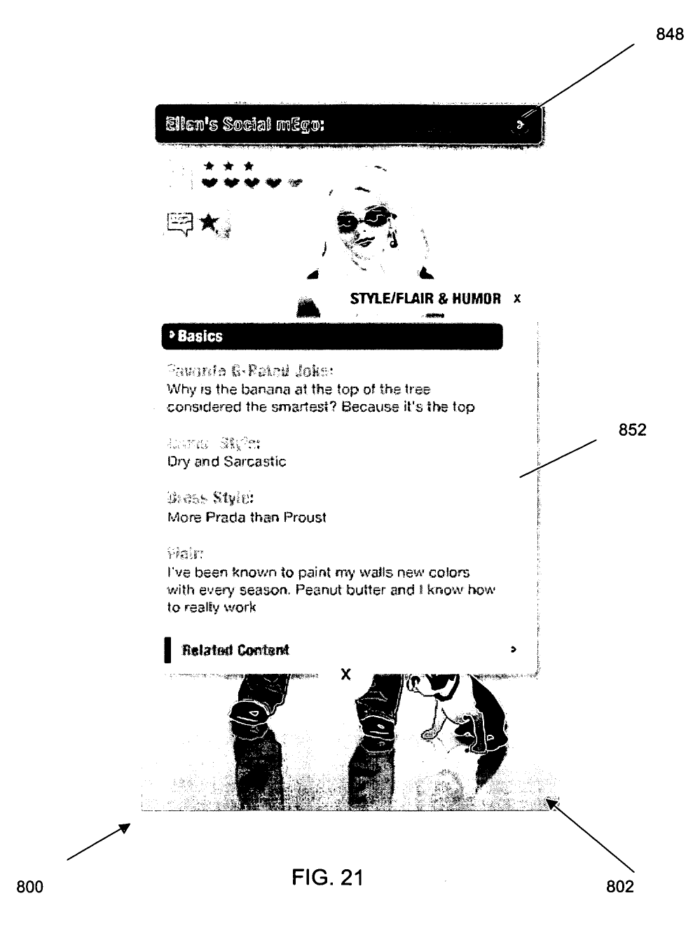

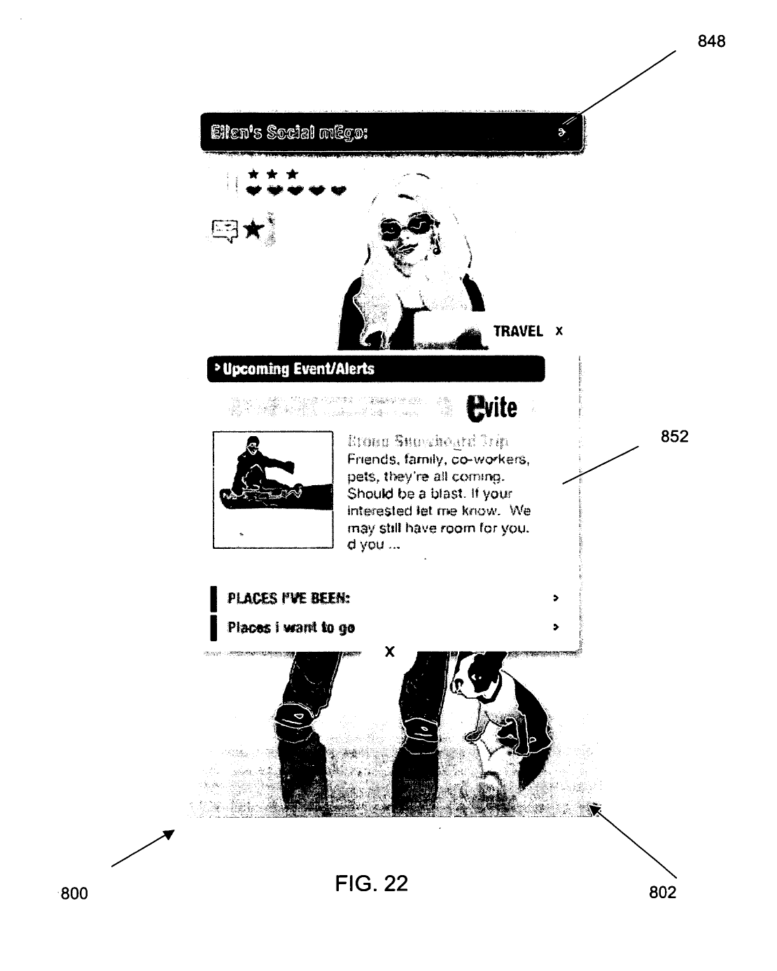

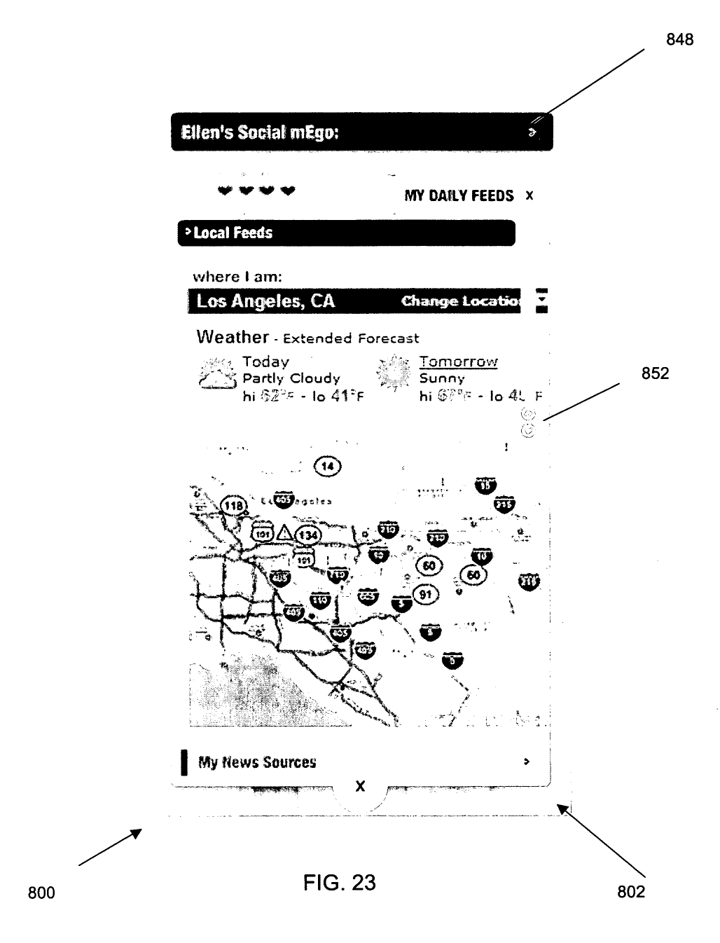

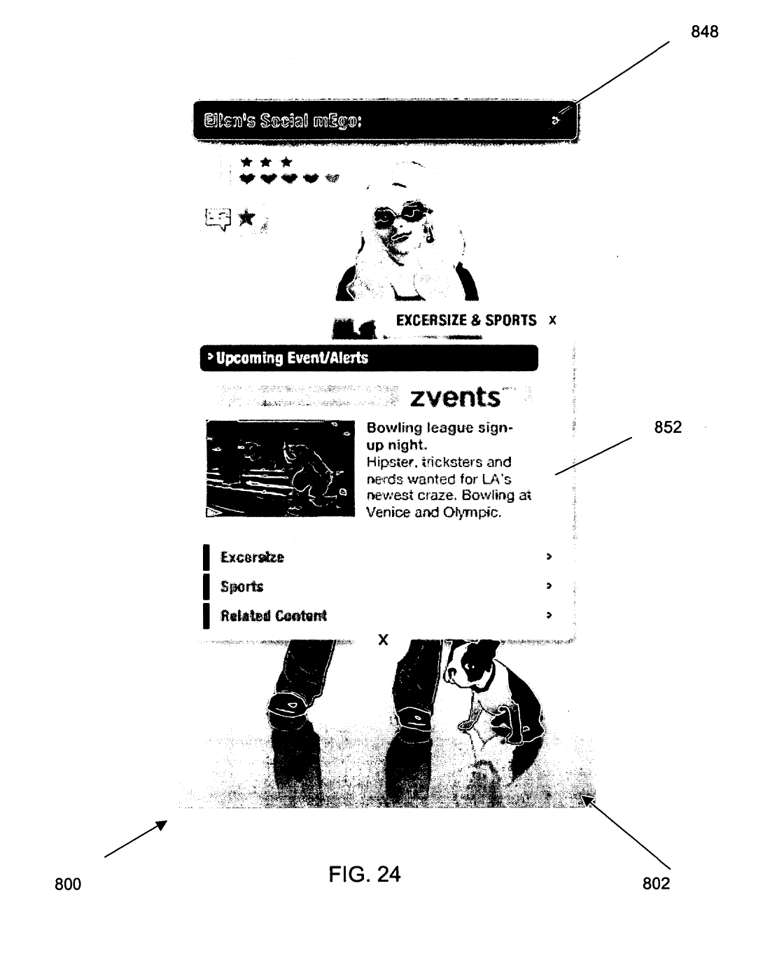

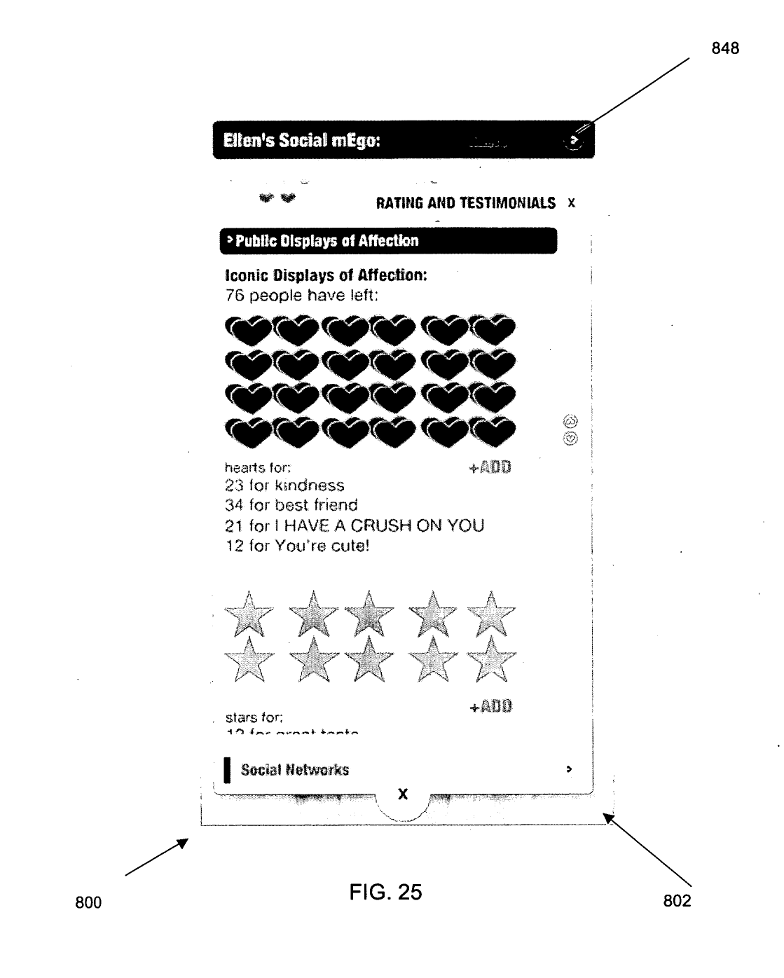

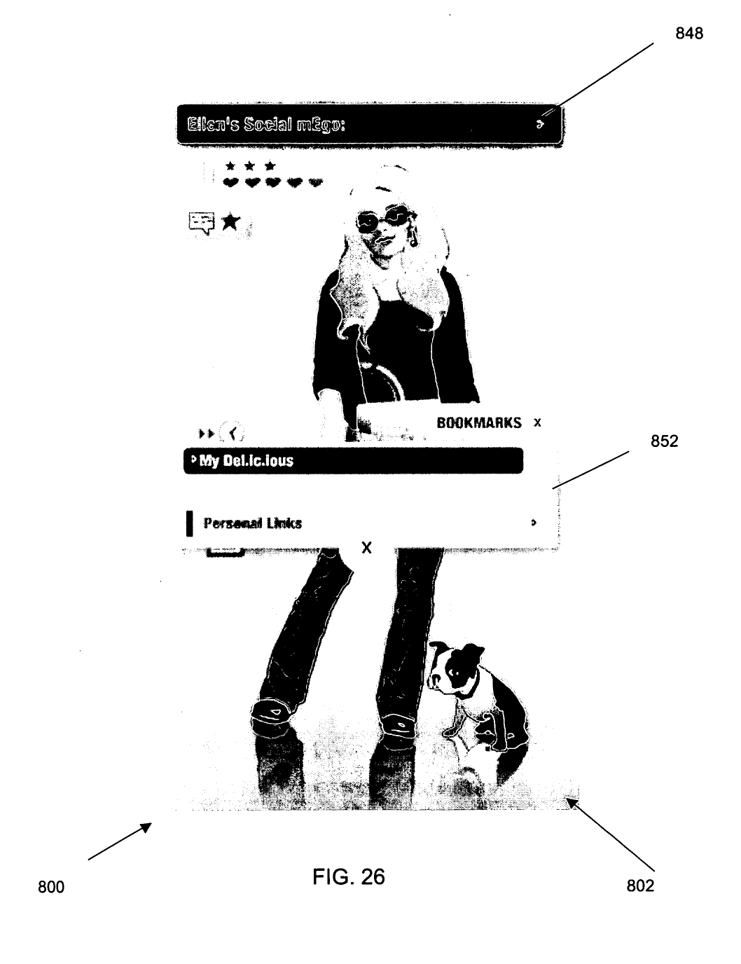

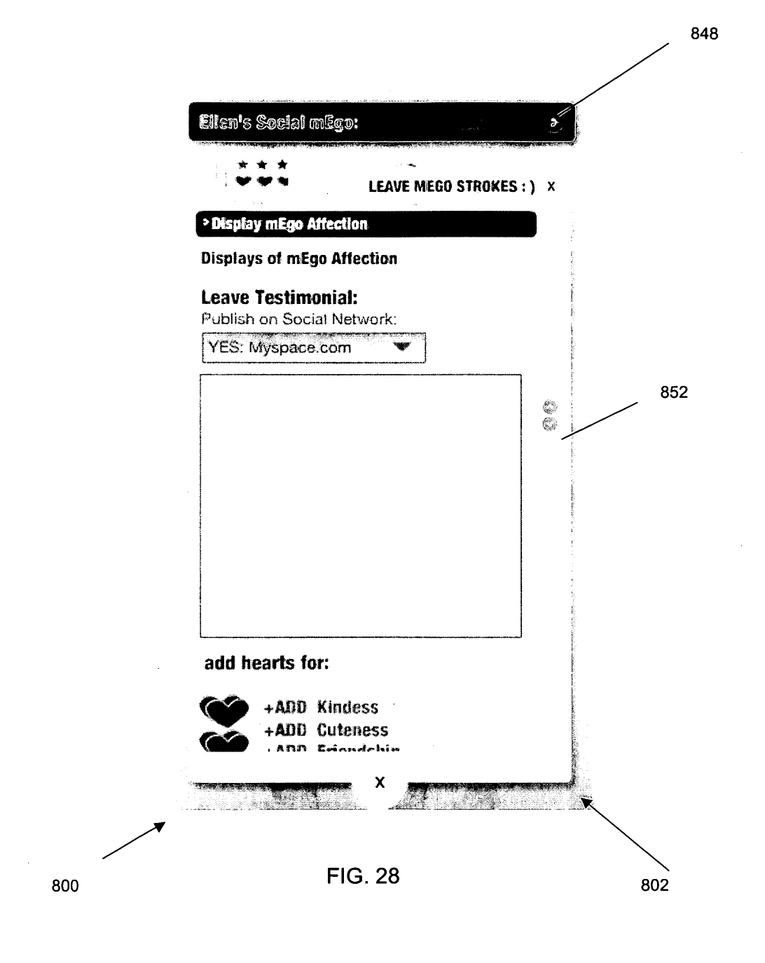

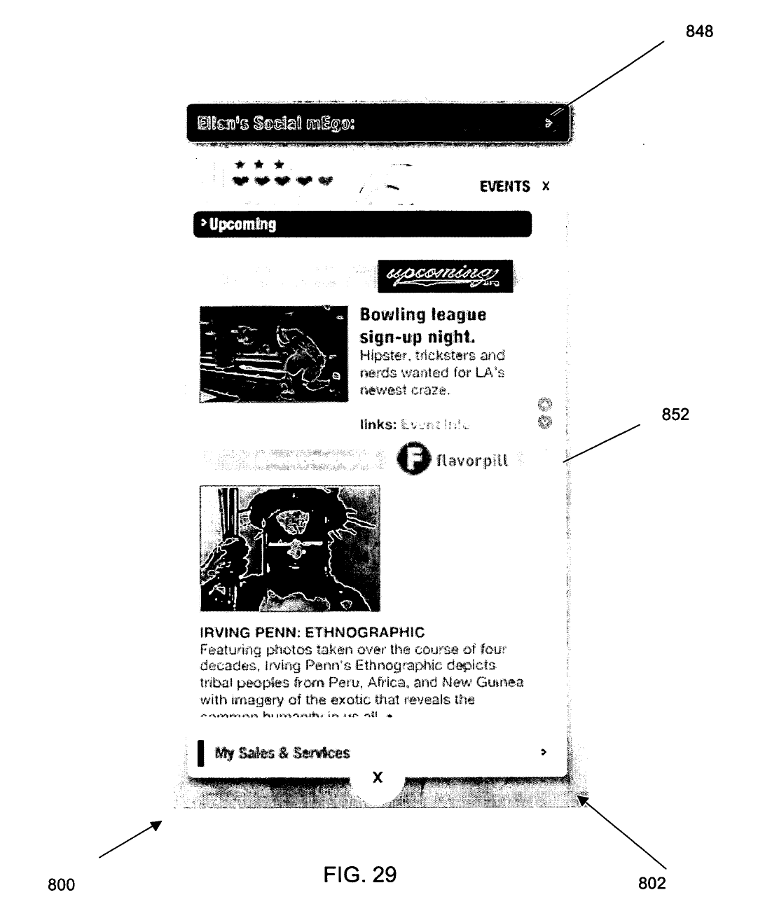

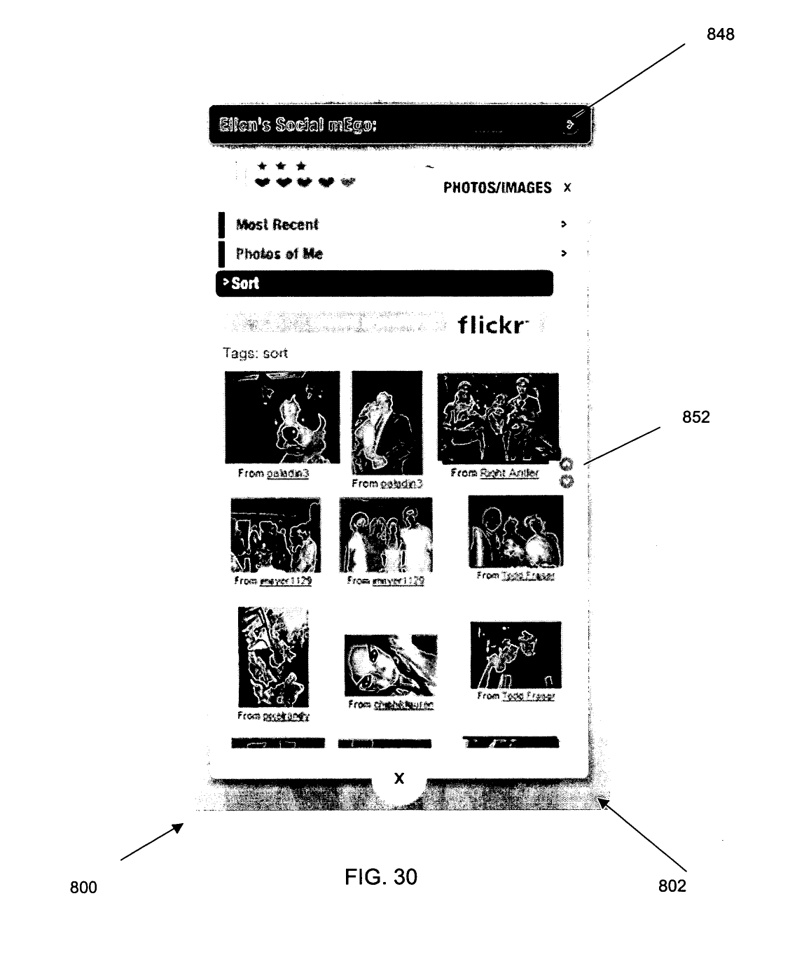

Reference is now made to FIGS. 10 to 30. Each of these FIGS. 15 illustrates user interface view 800 with a different iconographic element of representation 802 selected. In each case a window 852 displays attribute related information.

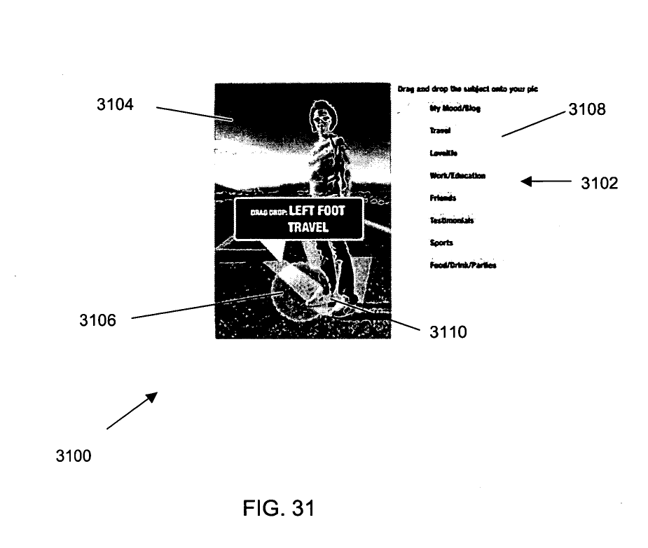

Reference is now made to FIG. 31, which illustrates an exemplary user interface 3100 for defining iconographic elements and associating them with particular attribute sets. In particular, this user interface 3100 allows the user to define, according to her or his own preferences, what the iconographic elements are and to which attributes they correspond. This process corresponds to step (306) of FIG. 3.

User interface 3100 comprises a plurality of attribute set buttons 3102. In this case, the user is using a photographic image 3104 as her representation. In this exemplary embodiment, the user can select one of the attribute buttons 3102. This causes an object 3106 to appear which defines the area that corresponds to an iconographic element. The user then moves the object 3106 to the area that corresponds to the desired element on the image. The user can format the size and shape of the object 3106 so that it corresponds more closely to the size and shape of the desired element. In this particular case, the user has selected the attribute set “travel” 3108 and chosen to have it correspond with the foot 3110 on the left side of the image 3104.

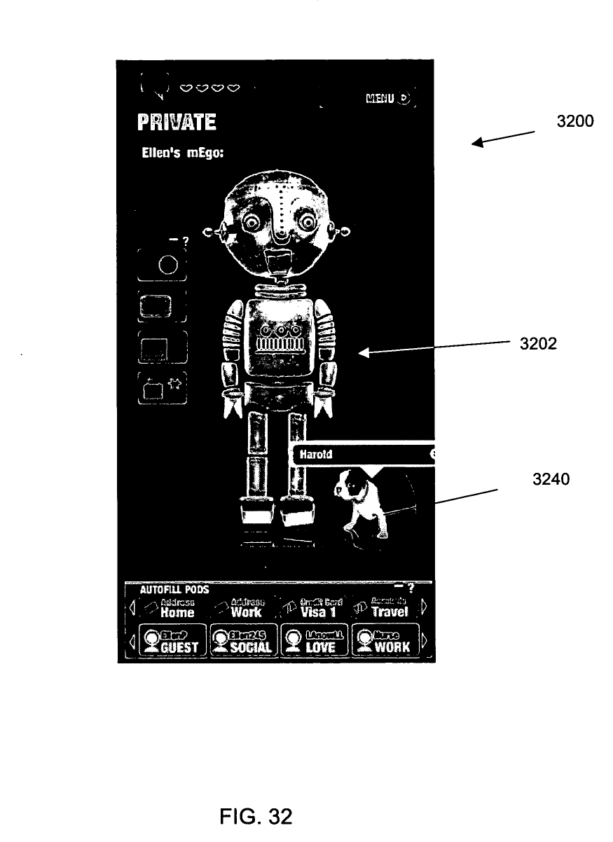

Reference is now made to FIGS. 32 to 34, which illustrate the user interface 3200 seen by the user when updating attributes. In the example illustrated, the user is adding an image to the pet attribute set. FIG. 32 illustrates a user interface 3200 of a representation 3202. This representation is for the same subject as that in FIG. 32. However, this representation is the user's private or utility representation. In FIG. 8, it can be seen that the user has selected iconographic element 3240 associated with the pet attribute set.

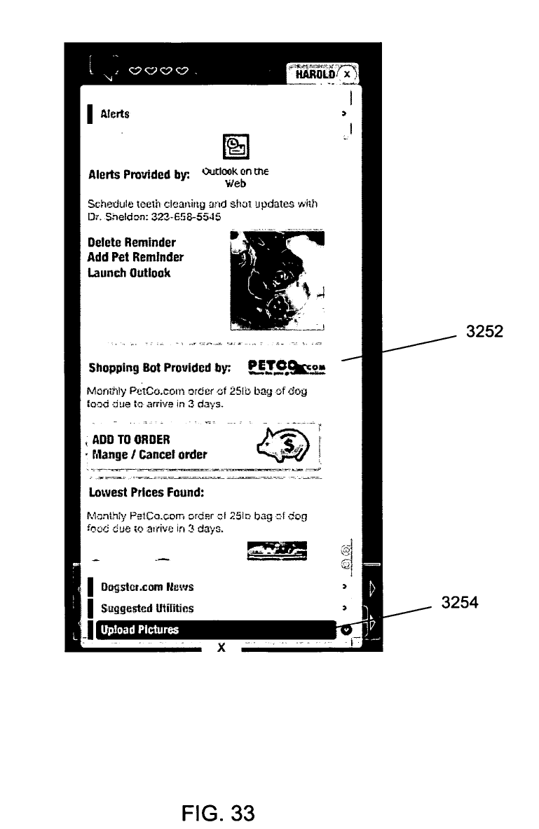

Reference is now made to FIG. 33. The selection of the iconographic element 3240 associated with the pet attribute set causes a window 3252 to appear. As can be seen, the user has selected the “Upload Pictures” button 3254.

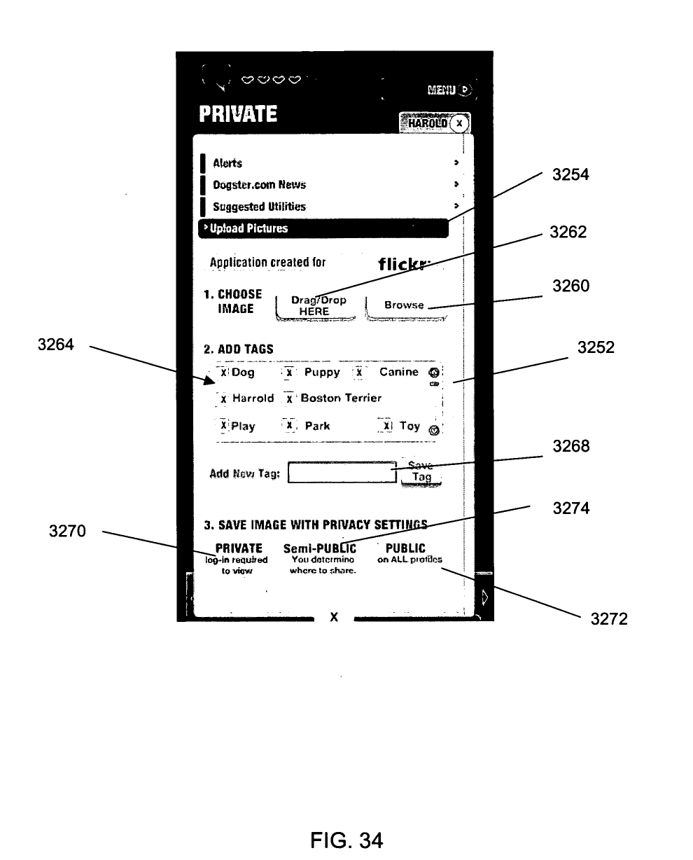

Reference is now made to FIG. 34. The selection of button 3254 causes screen 3252 to change such that the user is provided with an interface for uploading pictures. In particular, the user may browse for image files by selecting the “Browse” button 3260, or the user may drag and drop an image file onto the “Drag/Drop HERE” button 3262.

In addition, attribute mapping system 10 allows the user to have tags added to the images by selecting appropriate tag boxes 3264. The user can enter new tags by inputting appropriate information in box 3268. The user can select one of three buttons 3270, 3272, and 3274. Selecting the button 3270 will cause the image to only be displayed with the private and utility representations. Selecting button 3272 will cause the image to be displayed with all representations. Selecting button 3274 will allow the user to determine the individual representations on which the images will be displayed.

There are many advantages to this process. It offers users a set of prefabricated tags to which the user can add his or her own tags. This makes it easier to tag photos and it helps to avoid mistakes such as misspelling of tags. The alternative would be to allow the user to enter tags each time a photo is uploaded. This would not only be tedious but also prone to error. Thus, this feature helps to ensure that photos are properly tagged according to their context. The contextual tags can then be used to determine which attribute sets the photos should be displayed with.

It should be understood that the above-described process for uploading images is intended to be exemplary only and is not intended to be limiting in any way. Furthermore, similar interfaces could be provided for uploading other media or content to other attribute sets.

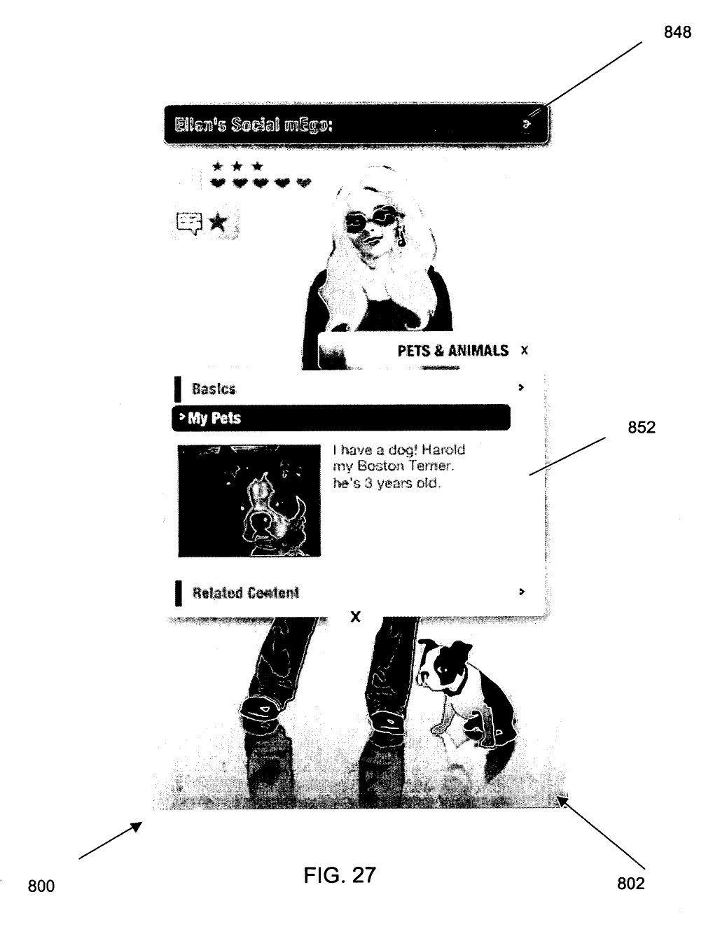

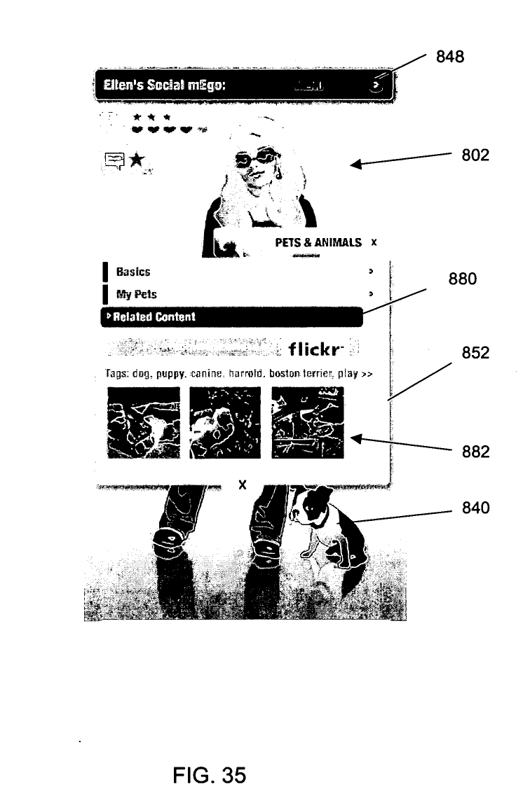

Reference is now made to FIG. 35, which illustrates the user interface 800 having representation 802, introduced above with reference to FIG. 8. As in FIG. 27, the iconographic element 840 associated with the pet attribute set has been selected. The difference is that in FIG. 35 the “related content” button 880 has been selected. This causes the images 882 that have been uploaded by the user to be displayed. Given that this is a social representation, only those images that have been designated as public or viewable on the social representation will be displayed.

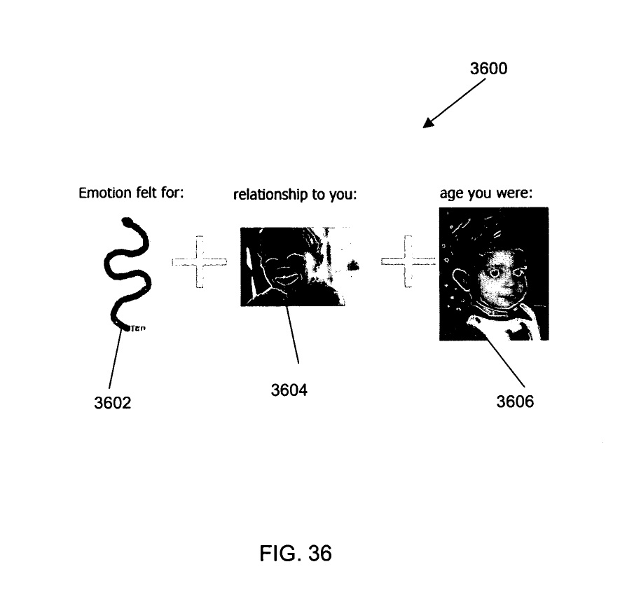

Reference is now made to FIG. 36, which illustrates a display 3600 used to help create passwords. Attribute mapping system can include a password management and creation module 22. The user can use this utility for assistance in creating and managing personalized passwords for anything that may require a password. The password manager can suggest passwords based on information inputted by the user. For example, the user may have inputted the three images 3602, 3604, and 3606. Consider the situation in which the user applied the tags “snake, respect canyon and danger” to the first image 3602. To the second image 3604 the user applied the tag “nephew.” To the last image 3606 the user applied the tag “Myself at 2”. The password utility can then suggest that the user combine the first three letters of the emotion for image 3602, the first three letters for the relationship to the person in image 3604, and the number representing the age in image 3606. This is only meant as an example and is not intended to be limiting in any way. In particular, the number of letters the position of the letters and the choice of tags or images could all be different.

The password module 22 can then store the puzzle instead of the actual password. Moreover, it can store the pieces of the puzzle in various locations such as password puzzle database 30. These features provide greater security and significantly lessen the chance that an unauthorized party will discover the password.

It will be appreciated that while the present invention has been described in the context of various methods including methods for creating electronic profiles and representations, it should be understood that it is equally applicable to other types of profiles and representations. The system, processes and methods of the present invention are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for creating a representation having at least two iconographic elements to represent at least two attributes of a subject, said method comprising:
(a) defining first and second iconographic elements of the representation;
(b) defining first and second attribute sets;
(c) associating the first attribute set with the first iconographic element and associating the second attribute set with the second iconographic element;
(d) defining first and second attributes of the subject;
(e) associating the first attribute with the first attribute set and associating the second attribute with the second attribute set;
(f) displaying the first and second iconographic elements;
(g) determining whether one of the displayed iconographic elements is selected; and
(h) if (g) is true, then displaying the associated attribute of the associated attribute set.

2. The method of claim 1, wherein (g) further includes determining whether the associated attribute of the associated attribute set should be displayed.

3. The method of claim 2, wherein each of the first and second attributes is defined as being either a viewable attribute or a non-viewable attribute with respect to the representation.

4. The method of claim 3, further comprising:
(i) determining whether the associated attribute is a viewable attribute with respect to the representation;
(j) if (i) is true, then displaying the associated attribute of the associated attribute set.

5. The method of claim 1, wherein at least part of the representation is an avatar representing a selected representation of the subject.

6. The method of claim 1, wherein at least part of the representation is an avatar and at least one of the first and second iconographic elements is a body part of the avatar, the body part being selected from a group consisting of: face, hair, eye, ear, nose, mouth, neck, heart, forehead, cheek, shoulders, left arm, right arm, left elbow, right elbow, right hand, left hand, left foot, right foot, stomach, chest, groin, hips, left knee, right knee, left thigh, right thigh, left calf, right calf, left shin, right shin, left big toe, right big toe, ears, left heel, right heel.

7. The method of claim 1, wherein at least part of the representation is an avatar and at least one of the first and second iconographic elements is selected from a group consisting of: left shoe, right shoe, hat, aura, neck, clothing, pants, skirts, shirts, jackets, watch, jewelry, pets, dogs, cats, fish, tattoos, emblems.

8. The method of claim 1, wherein at least one of the first and second attributes is selected from a group consisting of: music tastes, which comprise bands, songs, and genres, pod cast subscription feeds, online radio station links, band fan club links, mood, blog feed, lovelife preferences, diet, interests, hobbies, career, searching, communication, instant messaging, security, clothing sizes, shopping preferences, financial information, vacation data, sport interests, media preferences, Neflix lists, local theater times, playlists, favorite sites, favorite designers, favorite celebrities, upcoming events, bookmarks, password protectors, shopping bots, autofill sets for items such as online wallet, travel preferences, price watcher, sales manager, wishlists, dictionary, newest matches, romance tips, photo uploaders, weather feeds, news headline feeds, personality type, astrological forecast, food ordering, local delivery, recipe finder, recipe ranker, recipe sorter, party planner, invites, ratings for places, diet tools, search engine preferences, testimonials, real world basic autobiographical description(s), skills career and educational information.

9. The method of claim 1, further comprising:
(k) searching a network using a software agent for items of interest based on the attributes of the subject.

10. The method of claim 1 further comprising:
(I) determining and suggesting appropriate utilities based on the attributes of the subject.

11. The method of claim 9, wherein the network is the Internet.

12. The method of claim 9, further comprising:
(m) upon finding an item of interest, augmenting the iconographic element associated with the attribute set containing the attribute that was used to find the item, to indicate that an item of interest has been found.

13. The method of claim 10, further comprising:
(n) upon determining an appropriate utility, augmenting the iconographic element associated with the attribute set containing the attribute used to find and suggest the utility, to indicate that a utility of possible interest has been suggested.

14. A system for creating a representation having at least two iconographic elements to represent at least two attributes of a subject, said system comprising:
(a) a memory for storing first and second iconographic elements of the representation, first and second attributes, and first and second attribute sets of the subject;
(b) a processor coupled to the memory for:
(i) associating the first attribute set with the first iconographic element and associating the second attribute set with the second iconographic element;
(ii) associating the first attribute with the first attribute set and associating the second attribute with the second attribute set;
(iii) displaying the first and second iconographic elements;
(iv) determining whether one of the displayed iconographic elements is selected; and
(v) if (iv) is true, then displaying the associated attribute of the associated attribute set.

15. The system of claim 14, wherein the processor in (iv) also determines whether the associated attribute of the associated attribute set should be displayed.

16. The system of claim 15, wherein each of the first and second attributes is defined as being either a viewable attribute or a non-viewable attribute with respect to the representation.

17. The system of claim 16, wherein the processor also:
(vi) determines whether the associated attribute of the associated attribute set is a viewable attribute with respect to the representation;
(vii) if (vi) is true, displaying the associated attribute of the associated attribute set.

18. The system of claim 14, wherein at least part of the representation is an avatar representing a selected representation of the subject.

19. The system of claim 14, wherein at least part of the representation is an avatar and at least one of the first and second iconographic elements is a body part of the avatar, the body parts being selected from a group consisting of: face, hair, eye, ear, nose, mouth, neck, heart, forehead, cheek, shoulders, left arm, right arm, left elbow, right elbow, right hand, left hand, left foot, right foot, stomach, chest, groin, hips, left knee, right knee, left thigh, right thigh, left calf, right calf, left shin, right shin, left big toe, right big toe, ears, left heel, right heel.

20. The system of claim 14, wherein at least part of the representation is an avatar and at least one of the first and second iconographic elements is selected from a group consisting of: left shoe, right shoe, hat, aura, neck, clothing, pants, skirts, shirts, jackets, watch, jewelry, pets, dogs, cats, fish, tattoos, emblems.

21. The system of claim 14, wherein at least one of the first and second attributes is selected from a group consisting of: music tastes, which comprise bands, songs, and genres, pod cast subscription feeds, online radio station links, band fan club links, mood, blog feed, lovelife preferences, diet, interests, hobbies, career, searching, communication, instant messaging, security, clothing sizes, shopping preferences, financial information, vacation data, sport interests, media preferences, Neflix lists, local theater times, playlists, favorite sites, favorite designers, favorite celebrities, upcoming events, bookmarks, password protectors, shopping bots, autofill sets for items such as online wallet, travel preferences, price watcher, sales manager, wishlists, dictionary, newest matches, romance tips, photo uploaders, weather feeds, news headline feeds, personality type, astrological forecast, food ordering, local delivery, recipe finder, recipe ranker, recipe sorter, party planner, invites, ratings for places, diet tools, search engine preferences, testimonials, real world basic autobiographical description(s), skills career and educational information.

22. The system of claim 14, further including a network coupled to the processor, and wherein the processor also uses a software agent to search the network for items of interest based on the attributes.

23. The system of claim 14, wherein the processor also determines and suggests appropriate utilities based on the attributes of the subject.

24. The system of claim 22, wherein the network is the Internet.

25. The system of claim 22, wherein the processor further upon finding an item, augments the iconographic element associated with the attribute set containing the attribute used to find the item, to indicate that an item of interest has been found.

26. The system of claim 23, wherein the processor further, upon determining an appropriate utility, augments the iconographic element associated with the attribute set containing the attribute used to find and suggest the utility, to indicate that a utility of possible interest has been suggested.

27. A computer-readable medium having stored thereon a plurality of instructions, the plurality of instructions including instructions which, when executed by a processor, cause the processor to perform a method for creating a representation having at least one iconographic element to represent at least one attribute of a subject, said method comprising:
(a) defining first and second iconographic elements of the representation;
(b) defining first and second attribute sets;
(c) associating the first attribute set with the first iconographic element and associating the second attribute set with the second iconographic element;
(d) defining first and second attributes of the subject;
(e) associating the first attribute with the first attribute set and associating the second attribute with the second attribute set;
(f) displaying the first and second iconographic elements;
(g) determining whether one of the displayed iconographic elements is selected; and
(h) if (g) is true, then displaying the associated attribute of the associated attribute set.

28. The medium of claim 27, wherein (g) further includes determining whether the associated attribute of the associated attribute set should be displayed.

29. The medium of claim 28, wherein each of the first and second attributes is defined as being either a viewable attribute or a non-viewable attribute with respect to the representation.

30. The medium of claim 28, further comprising:
(i) determining whether the associated attribute is a viewable attribute with respect to the representation;
(j) if (h) is true, then displaying the associated attribute of the associated attribute set.

31. The medium of claim 27, wherein at least part of the representation is an avatar representing a selected representation of the subject.

32. The medium of claim 27, wherein at least part of the representation is an avatar and at least one of the first and second iconographic elements is a body part of the avatar, the body part being selected from a group consisting of: face, hair, eye, ear, nose, mouth, neck, heart, forehead, cheek, shoulders, left arm, right arm, left elbow, right elbow, right hand, left hand, left foot, right foot, stomach, chest, groin, hips, left knee, right knee, left thigh, right thigh, left calf, right calf, left shin, right shin, left big toe, right big toe, ears, left heel, right heel.

33. The medium of claim 27, wherein at least part of the representation is an avatar and at least one of the first and second iconographic elements is selected from a group consisting of: wherein the other iconographic elements are selected from left shoe, right shoe, hat, aura, neck, clothing, pants, skirts, shirts, jackets, watch, jewelry, pets, dogs, cats, fish, tattoos, emblems.

34. The medium of claim 25, wherein at least one of the first and second attributes is selected from a group consisting of: music tastes, which comprise bands, songs, and genres, pod cast subscription feeds, online radio station links, band fan club links, mood, blog feed, lovelife preferences, diet, interests, hobbies, career, searching, communication, instant messaging, security, clothing sizes, shopping preferences, financial information, vacation data, sport interests, media preferences, Neflix lists, local theater times, playlists, favorite sites, favorite designers, favorite celebrities, upcoming events, bookmarks, password protectors, shopping bots, autofill sets for items such as online wallet, travel preferences, price watcher, sales manager, wishlists, dictionary, newest matches, romance tips, photo uploaders, weather feeds, news headline feeds, personality type, astrological forecast, food ordering, local delivery, recipe finder, recipe ranker, recipe sorter, party planner, invites, ratings for places, diet tools, search engine preferences, testimonials, real world basic autobiographical description(s), skills career and educational information.

35. The medium of claim 27, further comprising
(k) searching a network using a software agent for items of interest based on the attributes of the subject.

36. The medium of claim 27, further comprising
(I) determining and suggesting appropriate utilities based on the attributes of the subject.

37. The medium of claim 35, wherein the network is the Internet.

38. The medium of claim 35, further comprising;
(m) upon finding an item of interest, augmenting the iconographic element associated with the attribute set containing the attribute that was used to find the item, to indicate that an item of interest has been found.

39. The medium of claim 36, further comprising:
(n) upon determining an appropriate utility, augmenting the iconographic element associated with the attribute set containing the attribute used to find and suggest the utility, to indicate that a utility of possible interest has been suggested.
